(19) United States
(12) Patent Application Publication
(10) Pub. No.: US 2014/0333713 A1
(43) Pub. Date: Nov. 13, 2014

(54) Video Calling and Conferencing Addressing

(71) Applicant: Biscotti Inc., McKinney, TX (US)

(72) Inventors: Matthew B. Shoemake, Allen, TX (US); Syed Nadeem Ahmed, Allen, TX (US)

(21) Appl. No.: 14/341,009

(22) Filed: Jul. 25, 2014

Related U.S. Application Data
(63) Continuation-in-part of application No. 14/106,263, filed on Dec. 13, 2013.
Application No. 14/106,263 is a continuation-in-part of application No. 14/170,499, filed on Jan. 31, 2014.
Application No. 14/170,499 is a continuation-in-part of application No. 14/106,279, filed on Dec. 13, 2013.
Application No. 14/106,279 is a continuation-in-part of application No. 14/106,360, filed on Dec. 13, 2013.
(60) Provisional application No. 61/987,304, filed on May 1, 2014.
(60) Provisional application No. 61/877,928, filed on Sep. 13, 2013.
(60) Provisional application No. 61/874,903, filed on Sep. 6, 2013.
(60) Provisional application No. 61/872,603, filed on Aug. 30, 2013.
(60) Provisional application No. 61/858,518, filed on Jul. 25, 2013.
(60) Provisional application No. 61/737,506, filed on Dec. 14, 2012.
(60) Provisional application No. 61/759,621, filed on Feb. 1, 2013.
(60) Provisional application No. 61/877,928, filed on Sep. 13, 2013.

(51) Int. Cl. H04L 29/06; H04L 29/08; H04N 7/15; H04M 7/00

(52) U.S. Cl. CPC H04L 65/1069; H04M 7/0006; H04L 67/025; H04L 65/403; H04N 7/15
USPC 348/14.05; 370/352; 370/261

(57) ABSTRACT

Novel tools and techniques are provided for implementing video calling and conferencing addressing. A computer might receive a call request from a caller. The call request might include a callee address in a first protocol. In some cases, the callee address might include a uniform resource locator (“URL”) associated with the callee, and the first protocol might be hypertext transfer protocol (“HTTP”). The computer might determine a callee at a calling destination based at least in part on the URL associated with the callee or callee's device(s), and might establish a voice or video call between the caller and the callee based at least in part on the URL associated with the callee (or callee's device(s)). In some cases, the computer might map the callee address in a second protocol (e.g., SIP, XMPP, PSTN protocol, etc.) different from the first protocol, and might call the callee using the second protocol.

### CROSS-REFERENCES TO RELATED APPLICATIONS

This application claims the benefit, under 35 U.S.C. §119(e), of the following applications: provisional U.S. Patent Application No. 61/987,304, filed May 1, 2014 by Shoemake et al. and titled “Virtual Remote Functionality” (attorney docket no. 0414.15-PR, referred to herein as the “'304 application”); provisional U.S. Patent Application No. 61/877,928, filed Sep. 13, 2013 by Ahmed et al. and titled “Mobile Presence Detection” (attorney docket no. 0414.12-PR, referred to herein as the “'928 application”); provisional U.S. Patent Application No. 61/874,903, filed Sep. 6, 2013 by Shoemake et al. and titled “Virtual Window” (attorney docket no. 0414.11-PR, referred to herein as the “'903 application”); provisional U.S. Patent Application No. 61/872,603, filed Aug. 30, 2013 by Shoemake et al. and titled “Physical Presence and Advertising” (attorney docket no. 0414.10-PR, referred to herein as the “'603 application”); and provisional U.S. Patent Application No. 61/858,518, filed Jul. 25, 2013 by Shoemake et al. and titled “Video Calling and Conferencing Advertising” (attorney docket no. 0414.08-PR, referred to herein as the “'518 application”). This application is a continuation-in-part of U.S. patent application Ser. No. 14/106,263, filed on Dec. 13, 2013 by Shoemake et al. and titled “Video Capture, Processing and Distribution System” (attorney docket no. 0414.06, referred to herein as the “'263 application”), which claims the benefit of provisional U.S. Patent Application No. 61/737,506, filed Dec. 14, 2012 by Shoemake et al. and titled “Video Capture, Processing and Distribution System” (attorney docket no. 0414.06-PR, referred to herein as the “'506 application”). This application is also a continuation in part of U.S. patent application Ser. No. 14/170,499, filed on Jan. 31, 2014 by Shoemake et al. and titled “Video Mail Capture, Processing and Distribution” (attorney docket no. 0414.07, referred to herein as the “'499 application”), which claims the benefit of provisional U.S. Patent Application No. 61/759,621, filed Feb. 1, 2013 by Shoemake et al. and titled “Video Mail Capture, Processing and Distribution” (attorney docket no. 0414.07-PR, referred to herein as the “'621 application”). This application is also a continuation in part of U.S. patent application Ser. No. 14/106,279, filed on Dec. 13, 2013 by Ahmed et al. and titled “Mobile Presence Detection” (attorney docket no. 0414.12, referred to herein as the “'279 application”) and U.S. patent application Ser. No. 14/106,360, filed on Dec. 13, 2013 by Ahmed et al. and titled “Distributed Infrastructure” (attorney docket no. 0414.13, referred to herein as the “'360 application”). The '279 application claims the benefit of the '928 application.

The respective disclosures of these applications/patents (which this document refers to collectively as the “Related Applications”) are incorporated herein by reference in their entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to video calling, and, more particularly, to tools and techniques for enabling or implementing video or voice calling and conferencing addressing.

### BACKGROUND

Video calling and conferencing is inhibited by the inability to easily place calls. To facilitate video calls, participants need to be addressable, i.e., reachable to one another. Unlike traditional voice calls, which use a standardized numerical addressing, e.g., +1 123-456-7890, video calling and conferencing does not have a common addressing scheme and an easy way to make calls between participants. There are a number of proprietary systems such as Skype®, Facetime®, and Google Hangouts® that do not allow calling between networks. There are a number of protocols that are used for video calling, e.g., SIP/SIMPLE and XMPP/JINGLE, but none are universally open or can easily be entered into an electronic address book. Web addresses, e-mail addresses, and public switched telephone network (“PSTN”) addresses are address spaces with wide interoperability, but they are not used or designed for video calling.

Further, it is difficult to call between so-called “room systems” for video conferencing. These conferencing systems tend to have Internet protocol (“IP”) addresses associated with them, which are not user friendly. Meetings must be scheduled. If another person calls during a call, it is difficult to add them to the meeting or video conversation.

Web browsers are adding the ability to decode and encode video using video compression formats, such as VP8 or the like. However, they are not adding signaling for video calling. This leaves a need for smart signaling technology to bridge the chasm between being able to encode and decode video data and actually being able to easily place and receive calls.

Hence, there is a need for solutions that allow for more flexible video calling and conference addressing.

### BRIEF SUMMARY

Some embodiments described herein make video calling and conferencing easy. This can be done, in some embodiments, via use of web uniform resource locators (“URLs”) to initiate calls. Web URLs (commonly called “web addresses”) are easy to use, common, and easily recognizable. Certain embodiments described herein enable video calling based on URLs, thereby enabling users to use standard web addresses that they are already familiar with to place video calls.

Two types of web addressing are described, in accordance with particular exemplary embodiments. One approach translates web addresses to addresses based on a second protocol such as session initial protocol (“SIP”) or the like. Another approach uses no translation at all, and uses hypertext transfer protocol (“HTTP”) for transport without translation to another protocol. A method of easily supporting multi-party calling is also disclosed. It should be appreciated, of course, that other embodiments can employ different addressing schemes and methodologies.

The techniques described herein can be employed in a variety of video calling environments, and with a variety of different hardware and software configurations. Merely by way of example, these techniques can be used with video calling devices and systems described in detail in U.S. patent application Ser. No. 12/561,165, filed Sep. 16, 2009 by Shoemake et al. and titled “Real Time Video Communications System” (issued as U.S. Pat. No. 8,144,182) and in the '279, '360, '263, '506, '499, and '621 applications, each of which is incorporated by reference, as if set forth in full in this document, for all purposes.

The tools provided by various embodiments include, without limitation, methods, systems, and/or software products. Merely by way of example, a method might comprise one or more procedures, any or all of which are executed by a user device, a video calling device, a presence detection device (“PDD”) described in detail in the '279 application, and/or a computer system. Correspondingly, an embodiment might provide a user device, a video calling device, a PDD, and/or a computer system configured with instructions to perform one or more procedures in accordance with methods provided by various other embodiments. Similarly, a computer program might comprise a set of instructions that are executable by a user device, a video calling device, a PDD, and/or a computer system (and/or a processor therein) to perform such operations. In many cases, such software programs are encoded on physical, tangible, and/or non-transitory computer readable media (such as, to name but a few examples, optical media, magnetic media, and/or the like).

In an aspect, a method might comprise receiving, at a computer and from a caller, a call request including a callee address in a first protocol. The first protocol might be hypertext transfer protocol (“HTTP”), and the callee address might include a uniform resource locator (“URL”) associated with the callee. The method might further comprise determining, with the computer, a callee at a calling destination based at least in part on the URL associated with the callee, and establishing, with the computer, a call between the caller and the callee based at least in part on the URL associated with the callee.

In some embodiments, the computer might be a server located over a network. The URL associated with the callee might, in some cases, be a URL associated with at least one device associated with the callee.

According to some embodiments, establishing the call between the caller and the callee based at least in part on the URL associated with the callee might comprise mapping, with the computer, a callee address in a second protocol different from the first protocol, logging into a calling server that utilizes the second protocol, via the computer, and initiating, with the computer, a call to the callee address in the second protocol based on the mapping. In some instances, the second protocol might be session initiation protocol (“SIP”), and the callee address might include a SIP address associated with the callee. In some cases, the second protocol might be extensible messaging and presence protocol (“XMPP”), and the callee address might include an XMPP address associated with the callee (including, but not limited to, a Jabber ID or JID, which includes a username and one of a domain name or an Internet Protocol (“IP”) address). In some embodiments, the second protocol might be public switched telephone network (“PSTN”) protocol, and the callee address might include a telephone number associated with the callee.

Merely by way of example, in some cases, the call might be a video call. In some embodiments, the method might further comprise recording, with the computer, the video call and storing, with the computer, the recorded video call in a database. According to some embodiments, the callee might be one of a software application, a dedicated hardware device, a web browser, or a conferencing server for multiple callers. The conferencing server might perform aggregation and transcoding functions. The call request, in some cases, might be initiated by the caller entering the URL associated with the callee in a web browser.

In some embodiments, the method might further comprise receiving, with the computer, a request to share with the callee a display screen of a first device associated with the caller, and displaying the display screen of a first device on a screen of a second device associated with the callee, in response to receiving the request to share the display screen of a first device associated with the caller. In some instances, the method might further comprise receiving, with the computer, a request to share files with the callee, and transferring, with the computer, one or more files designated for sharing from a first device associated with the caller to a second device associated with the callee, in response to receiving the request to share files. In some cases, the method might further comprise receiving, with the computer, a request to provide the callee with control of a camera associated with the caller, and providing, with the computer, remote control of the camera associated with the caller to the callee. Remote control of the camera associated with the caller might include control of at least one of pan, tilt, or zoom of the camera. In some instances, the call might be a video call, and the camera might be a camera used by the caller during the video call.

According to some embodiments, the computer might be a HTTP server. Establishing the call between the caller and the callee based at least in part on the URL associated with the callee might comprise receiving, with the HTTP server and from a browser of a first device associated with the caller, a first notification indicating an incoming call, sending, with the HTTP server, a second notification to the callee indicating the incoming call, and relaying, with the HTTP server, control information and data to establish the call between the caller and the callee. In some instances, the HTTP server might have WebSocket (“WS”) connection functionality. In some embodiments, the method might further comprise routing, with the HTTP server, traffic over a content delivery network (“CDN”).

Alternatively, the computer might be a HTTP server and establishing the call between the caller and the callee based at least in part on the URL associated with the callee might comprise receiving, with the HTTP server and from a browser of a first device associated with the caller, a first notification indicating an incoming call; sending, with the HTTP server, a second notification to the callee indicating the incoming call; providing, with the HTTP server and to each of the first device associated with the caller and a second device associated with the callee, at least one of the caller address, the callee address, or control information and data; and establishing the call between the caller and the callee, by streaming the control information and data from each of the first device and the second device to the other of the first device and the second device.

In some embodiments, the method might further comprise maintaining, with the computer, a connection between the computer and a second device associated with the callee, and waking, with the computer, a browser running on the second device in response to receiving a notification of an incoming call. In some instances, maintaining, with the computer, the connection between the computer and the second device associated with the callee might comprise utilizing a WebSocket (“WS”) connection. In some cases, maintaining, with the computer, the connection between the computer and the second device associated with the callee might comprise associating the second device with the computer, authenticating an identity of the callee through the second device, and maintaining the connection based at least in part on the association and the authentication. According to some embodiments, waking, with the computer, the browser running on the second device might comprise waking, with the computer, the browser using a side communications channel between the computer and the second device. Alternatively, or in addition, waking, with the computer, the browser running on the second device might comprise simultaneously waking, with the computer, all browsers running on all devices associated the callee.

According to some embodiments, the method might further comprise receiving, with the computer and during the call between the caller and the callee, a request to establish a multi-party call with at least one additional call participant, and establishing, with the computer, a multi-party call connecting the caller, the callee, and each of the at least one additional call participant. The at least one additional call participant are separate from both the caller and the callee. In some cases, the request to establish the multi-party call might include a request to join the call that is received from the at least one additional call participant, and establishing the multi-party call might comprise sending, with the computer, a notification to each of the caller and the callee indicating the request to join the call that is received from the at least one additional call participant, and establishing, with the computer, a multi-party call connecting the caller, the callee, and each of the at least one additional call participant, in response to receiving, from one of the caller or the callee, instructions indicating acceptance of the multi-party call. Alternatively, the request to establish the multi-party call might include a request, from one of the caller or the callee, to add the at least one additional call participant to the call, and establishing the multi-party call might comprise establishing, with the computer, a multi-party call connecting the caller, the callee, and each of the at least one additional call participant, in response to receiving the request to add the at least one additional call participant to the call. In some cases, establishing, with the computer, a multi-party call connecting the caller, the callee, and each of the at least one additional call participant might comprise seamlessly transferring the multi-party call to a conferencing server.

In some embodiments, the method might further comprise receiving, with the computer and during a first call between the caller and the callee, a request from an additional caller to call one of the caller or the callee, the additional caller being separate from both the caller and the callee. The method might comprise, in response to receiving an “ignore call” user input response from the one of the caller or the callee, preventing establishment of a call connection between the additional caller and the one of the caller or the callee, without interrupting the first call. Alternatively, the method might comprise, in response to receiving a “switch call” user input response from the one of the caller or the callee, putting the first call on hold and establishing a second call between the additional caller and the one of the one of the caller or the callee. In response to receiving an “end call” user input response from the one of the caller or the callee to end the second call, the method might comprise automatically resuming the first call (in some cases, prior to the second call being completely ended).

In another aspect, an apparatus might comprise a non-transitory computer readable medium that is communicatively coupled to at least one processor. The computer readable medium might have stored thereon software comprising a set of instructions that, when executed by the at least one processor, causes the apparatus to perform one or more functions. The set of instructions might comprise instructions for receiving, from a caller, a call request including a callee address in a first protocol. The first protocol might be hypertext transfer protocol (“HTTP”), and the callee address might include a uniform resource locator (“URL”) associated with the callee. The set of instructions might further comprise instructions for determining a callee at a calling destination based at least in part on the URL associated with the callee and instructions for establishing a call between the caller and the callee based at least in part on the URL associated with the callee

In some embodiments, the apparatus might be a user device associated with the caller, where the instructions for establishing the call might comprise instructions for sending a request to a server over a network to establish the call. In some cases, the apparatus might be a server over a network. Merely by way of example, determining a callee at a destination based at least in part on the URL associated with the callee might be performed at the user device associated with the caller and/or at the server.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a block diagram illustrating a system for enabling or implementing video or voice calling and conferencing addressing, in accordance with various embodiments.

FIGS. 2A-2D are process flow diagrams illustrating various methods of enabling or implementing video or voice calling and conferencing addressing, in accordance with various embodiments.

FIG. 3 is a process flow diagram illustrating a method of waking one or more browsers running on one or more devices associated with a user in response to an incoming call, in accordance with various embodiments.

FIGS. 4A-4D are process flow diagrams illustrating various methods of enabling, handling, or implementing multi-party calls, in accordance with various embodiments.

FIGS. 5A-5D represent a system flow diagram illustrating a method for enabling or implementing video or voice calling and conferencing addressing, in accordance with various embodiments.

FIGS. 6A-6C are illustrations of user devices used by users that present exemplary graphical user interfaces for enabling or implementing video or voice calling and conferencing addressing, in accordance with various embodiments.

FIG. 7 is a generalized schematic diagram illustrating a computer system, in accordance with various embodiments.

FIG. 8 is a block diagram illustrating a networked system of computers, which can be used in accordance with various embodiments.

### DETAILED DESCRIPTION OF CERTAIN EMBODIMENTS

While various aspects and features of certain embodiments have been summarized above, the following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Features Provided By Various Embodiments

Video or Voice Calling and Conferencing Addressing

With technologies such as Facetime® from Apple, Skype® from Microsoft, and Hangouts® from Google, the entire calling experience is blocked from the outside world. In other words, calls just operate inside each of the proprietary systems (i.e., one of these communications platforms, or similar platforms) to place a call. There is no interoperability with third parties. This creates a segmented world of isolated, non-interoperable video (or voice) calling networks. A user cannot place inter-network or inter-platform calls.

With one approach below, this whole gated community approach is bypassed by (a) using standard HTTP that everyone has access to; (b) taking away the dependency of consumers on companies like Apple to get people to sign up (i.e., people are already using web browsers), so all a service provider needs to do is have its service working and to give others a user's URL, and that would enable people to call the user.

Various embodiments provide techniques for implementing video calling and conferencing addressing. A computer might receive a call request from a caller, in which the call request includes a callee address in a first protocol. In some cases, the callee address might include a uniform resource locator (“URL”) associated with the callee, and the first protocol might be hypertext transfer protocol (“HTTP”). The computer might determine a callee at a calling destination based at least in part on the URL associated with the callee or callee's device(s), and might establish a voice or video call between the caller and the callee based at least in part on the URL associated with the callee (or callee's device(s)).

In operation, establishing a voice or video call may be implemented by utilizing address translation. In such cases, the computer might map the callee address in a second protocol (e.g., SIP, XMPP, PSTN protocol, etc.) different from the first protocol (e.g., HTTP), and might call the callee using the second protocol. In other embodiments, calls may be established without address translation, which might involve either relaying all control information and data for establishing the call, or might provide for non-relayed/direct routing of all control information and data between user devices of the caller and the callee.

U.S. patent application Ser. No. 12/581,185 (issued as U.S. Pat. No. 8,144,182) (the “'182 patent,” the entire disclosure of which is hereby incorporated by reference for all purposes) discloses some exemplary video calling devices (also referred to in the '182 patent as video communication devices or VCDs) that can be used with embodiments disclosed herein. The PDD and/or ICD described in the '499 application (already incorporated by reference) can also be used as a video calling device, in accordance with various embodiments. The '263 application (already incorporated by reference) discloses systems for capturing and processing video, including remote control over a video or image capture device. Embodiments disclosed herein can be employed in the environment disclosed in the '263 application and/or in conjunction with the techniques described in the '263 application, and/or such embodiments can be employed and/or can be used in conjunction with video calling devices described in the '182 patent.

### Exemplary Embodiments

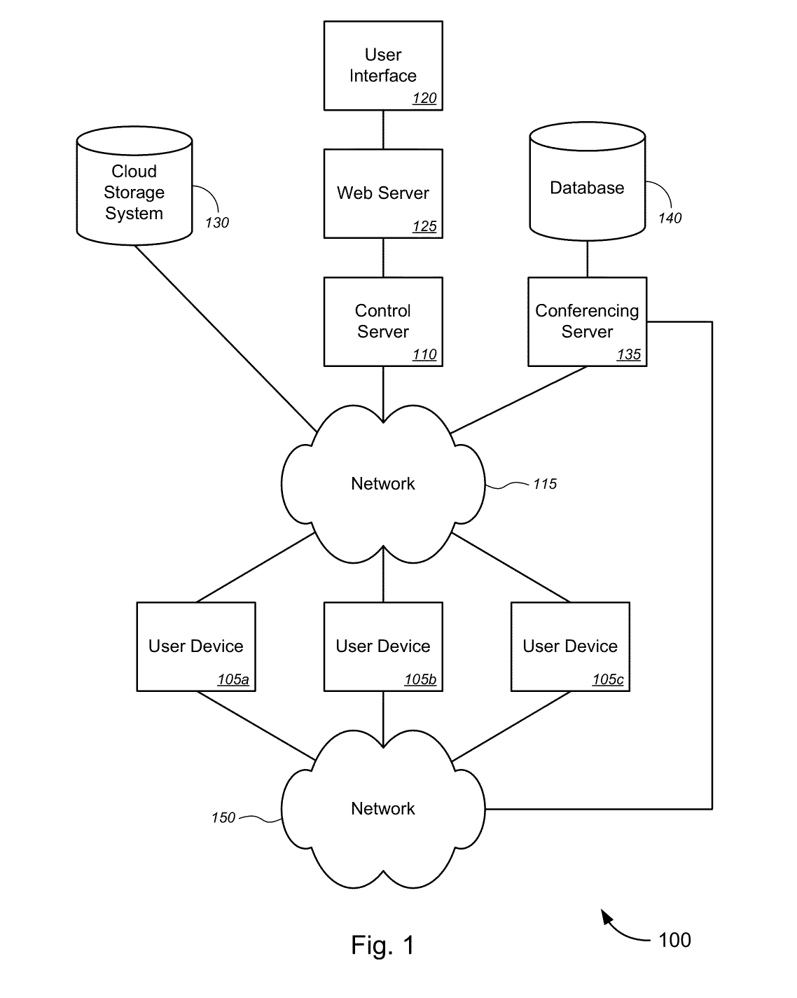

FIGS. 1-8 illustrate exemplary embodiments that can provide some or all of the features described above. The methods, systems, and apparatuses illustrated by FIGS. 1-8 may refer to examples of different embodiments that include various components and steps, which can be considered alternatives or which can be used in conjunction with one another in the various embodiments. The description of the illustrated methods, systems, and apparatuses shown in FIGS. 1-8 is provided for purposes of illustration and should not be considered to limit the scope of the different embodiments.

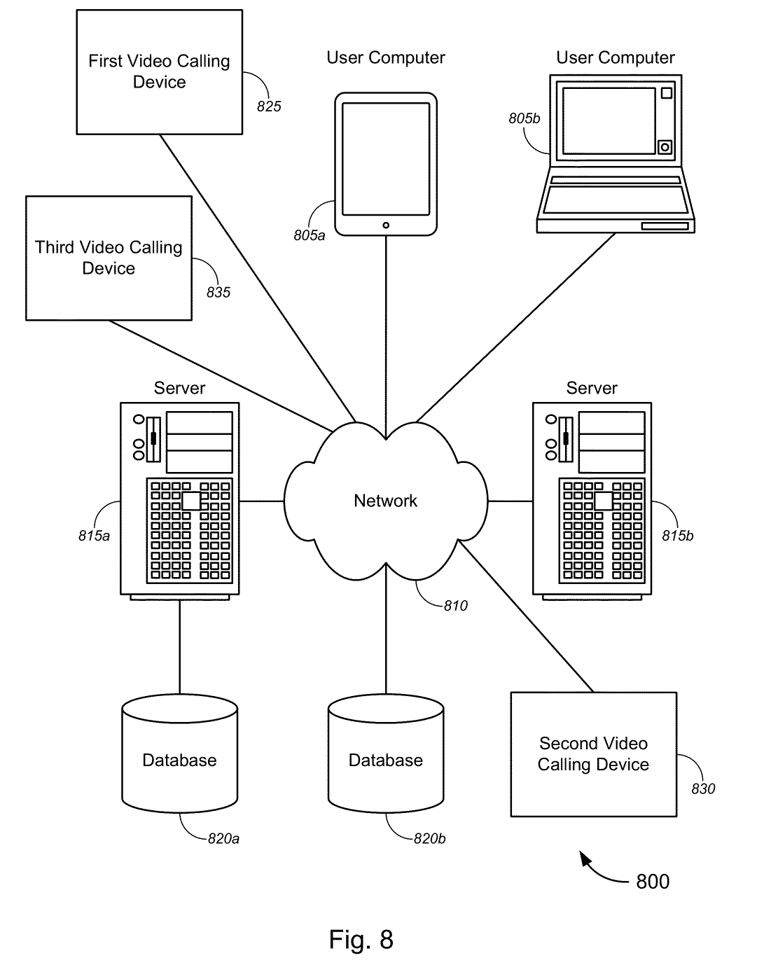

FIG. 1 illustrates a functional diagram of a system 100 for controlling one or more user devices 105, in accordance with various embodiments. The skilled reader should note that the arrangement of the components illustrated in FIG. 1 is functional in nature, and that various embodiments can employ a variety of different structural architectures. Merely by way of example, one exemplary, generalized architecture for the system 100 is described below with respect to FIG. 8, but any number of suitable hardware arrangements can be employed in accordance with different embodiments.

In some embodiments, the one or more user devices 105 might include one or more video calling devices. In some instances, the one or more user devices 105 might include one or more presence detection devices (“PDDs”), such as the presence detection devices (“PDDs”) described in the '279 application, and/or the like. A video calling device 105 or a user device 105 can be any device that is capable of communicating with a control server 110 over a network 115 and can provide any of a variety of types of video communication functionality. Merely by way of example, in some aspects, a video calling device 105 or a user device 105 can be capable of providing pass through video/audio to a display device (and/or audio playback device) from another source (such as a local content source), and/or overlaying such video/audio with additional content generated or received by the video calling device 105 or the user device 105. In other aspects, a video calling device 105 or a user device 105 can comprise one or more sensors (e.g., digital still cameras, video cameras, webcams, security cameras, microphones, infrared sensors, touch sensors, and/or the like), and/or can be capable, using data acquired by such sensors, of sensing the presence of a user, identifying a user, and/or receiving user input from a user; further, a video calling device 105 or a user device 105 can be capable of performing some or all of the other functions described herein and/or in the Related Applications. Hence, in various embodiments, a video calling device 105 or a user device 105 can be embodied by a video calling device, such as any of the video communication devices (“VCDs”) described in the '182 patent, a video game console, a streaming media player, to name a few non-limiting examples.

The system 100 can further include a control server 110, which can have any suitable hardware configuration, and an example of one such configuration is described below in relation to FIG. 8. In one aspect, the control server 110 is a computer that is capable of receiving user input via a user interface 120 and/or performing operations for utilizing the video calling device(s) 105 and/or the user device(s) 105 to send voice or video call requests in one or more first protocols, to receive voice or video calls using one or more second protocols, to establish multi-party voice or video calls, to notify the user or callee about an incoming call, to enable the user or callee to remotely access the user's master account, user preferences, and/or the like, for example as described in further detail below. In some embodiments, control server 110 might comprise a plurality of user devices 105 that are configured as distributed infrastructure devices in a cloud network environment, which is described in detail in the '360 application, which has been incorporated herein by reference in its entirety for all purposes. In some cases, particularly for video calls, videomail messaging functionality as described in detail in the '499 application (which has already been incorporated herein by reference in its entirety for all purposes) may be implemented in conjunction with the various embodiments described herein.

Merely by way of example, the control server 110 can receive a call request from a caller (e.g., through one of the user devices 105), in which the call request might include a callee address in a first protocol. In some embodiments, the first protocol might include a uniform resource locator (“URL”) associated with the callee, and the first protocol might be hypertext transfer protocol (“HTTP”). The control server 110 might determine a callee at a calling destination based at least in part on the URL associated with the callee or with one or more user devices 105 associated with the callee. The control server might establish a call (either voice or video call) between the caller and the callee based at least in part on the URL associated with the callee (or the callee's user device(s) 105). In some cases, as shown in FIG. 1, the control server 110 is located over network 115 with respect to any of the user devices 105. In some cases, the call request might be initiated by the caller entering the URL associated with the callee in a web browser. In some cases, the caller might follow, execute, or click on a URL hyperlink in a web browser (or other HTTP supported document or user interface (“UI”)).

In some embodiments, establishing the call between the caller and the callee might comprise the control server 110 mapping a callee address in a second protocol different from the first protocol, the control server 110 logging into a calling server (which in some cases might be conferencing server 135, another server 110, or the like) that utilizes the second protocol, and the control server 110 initiating a call to the callee address in the second protocol based on the mapping. In some cases, the second protocol might be session initiation protocol (“SIP”), and the callee address might include a SIP address associated with the callee. In some instances, the second protocol might be extensible messaging and presence protocol (“XMPP”), and the callee address might include an XMPP address associated with the callee; the XMPP address might include a Jabber identification or Jabber ID, which might include a username and domain name (or IP address). According to some embodiments, the second protocol might include public switched telephone network (“PSTN”) protocol, and the callee address might include a telephone number associated with the callee. In some instances, control server 110 might use port 80 (which is typically used in HTTP), which is commonly open by default by most firewalls and/or routers. For video calls, in some embodiments, the control server 110 might record the video call, and might store the recorded video call in a database (such as cloud storage system 130).

According to some embodiments, the callee might be one of a software application, a dedicated hardware device, a web browser, or a conferencing server for multiple callers, wherein the conferencing server (e.g., conferencing server 135 or the like) performs aggregation and transcoding functions. In some cases, the control server 110 might receive a request to share with the callee a display screen of a first device (e.g., user device 105a) associated with the caller, and might display the display screen of a first device on a screen of a second device (e.g., user device 105b) associated with the callee, in response to receiving the request to share the display screen of a first device (e.g., user device 105a) associated with the caller. In some instances, the control server 110 might receive a request to share files with the callee, and might transfer one or more files designated for sharing from a first device (e.g., user device 105a) associated with the caller to a second device (e.g., user device 105b) associated with the callee, in response to receiving the request to share files.

Merely by way of example, in some cases, placing a call (such as a voice or video call) might include a caller clicking, following, executing, or entering a URL associated with a callee (or a device of a callee). If necessary, the caller might have to download appropriate plugins for a web browser, and may be prompted to do so. Optionally, control server 110 might prompt for (or might access) user information for the caller, the user information including, without limitation, name, e-mail address, avatar, URL associated with the caller, and/or the like. If the user information for the caller is entered, such user information may be stored (e.g., in cloud storage system 130) such that entry of such user information is not needed on subsequent calls by the caller. The control server 110 might subsequently perform a database lookup (e.g., within either a local data store or within cloud storage system 130) to determine an address (and possibly a protocol, e.g., SIP, XMPP, PSTN, etc.) to be called, based on the URL. The control server 110 might then place or establish a call to the callee using the appropriate protocol (e.g., HTTP, SIP, XMPP, PSTN, etc.) and address determined above. In some cases, control server 110 might perform negotiation with other system components to establish routing of the call; to enable video on/off capability; for video bandwidth, resolution, and codec type; for audio bandwidth, data rate, and codec type; and/or the like.

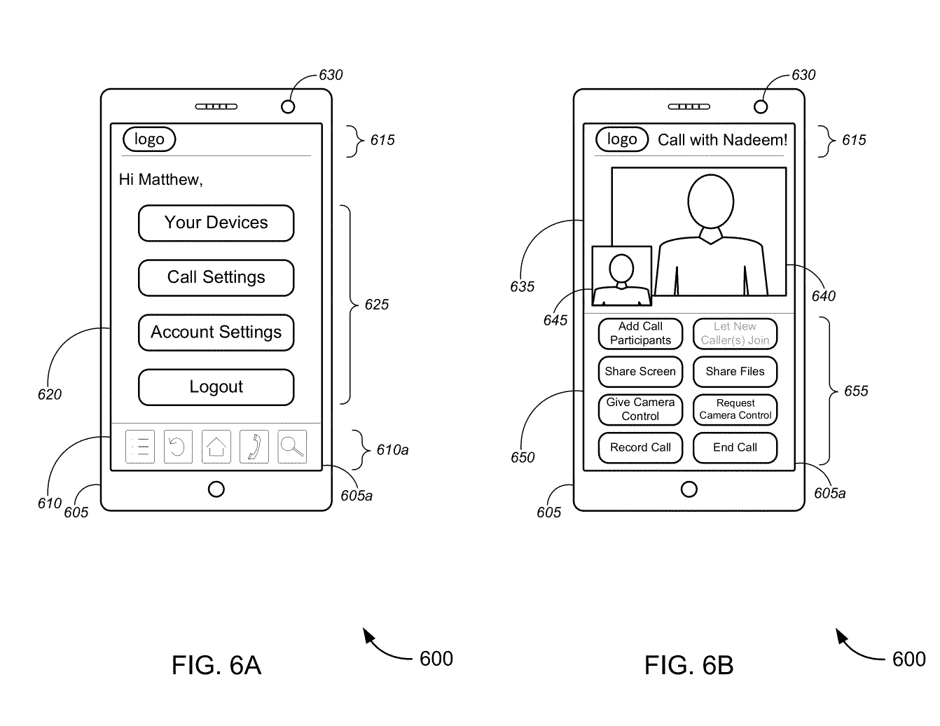

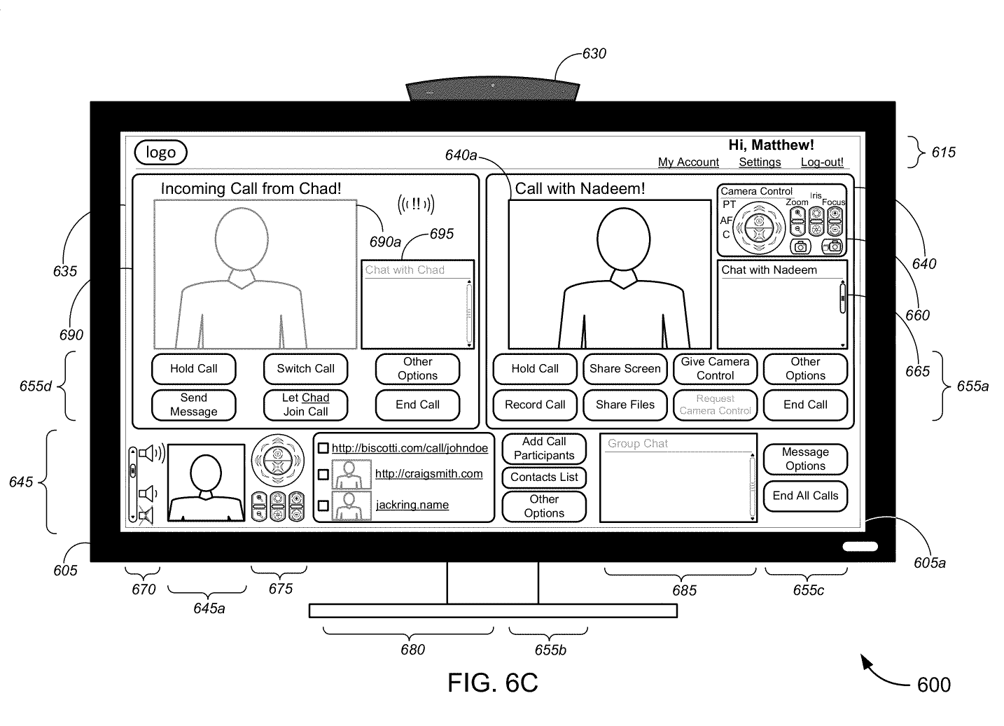

In some embodiments, the control server 110 might receive a request to provide the callee with control of a camera associated with the caller, and might provide remote control of the camera associated with the caller to the callee. In some cases, remote control of the camera associated with the caller might include control of at least one of pan, tilt, or zoom of the camera. In some instances, remote control of the camera might further include manual focus, auto focus, centering of the field of view, iris control, still image capture, multiple still image capture, and/or the like. Examples of such camera control is shown, e.g., in the embodiment of FIG. 6C. According to some embodiments, the call might be a video call, and the camera might be a camera used by the caller during the video call. Although the example described above is directed to providing the callee control of the camera of a device associated with the caller, the various embodiments are not so limited, and any of the call participants can provide control of his or her camera to any other(s) of the call participants.

Merely by way of example, in some aspects, web addresses may be used for calling, without translation to a secondary protocol (such as SIP, XMPP, PSTN, or the like). The web browser might connect to a HTTP server or address associated with a user (e.g., a callee). For example, a user might provide his or her address to the world as a URL (e.g., http://matthew.com). By following the link anyone with a browser could call the user. As a callee, the user might stay connected to the server (e.g., control server 110) all the time. A caller might connect to the server (e.g., control server 110, which might be a HTTP server), via the web address or URL, only when the caller wants to call the user. In such a case, there is no longer any need for PSTN. One intended benefit is that the call is done over HTTP, which is never blocked by firewalls. Service providers can also offer the new service to users, e.g., can provide users with a service whereby the user informs the world that people can call the user at a URL associated with the user (or with a device(s) associated with the user). Such people (i.e., callers) can place calls from their smartphones, tablet computers, desktop computers, and/or other suitable user devices (e.g., user devices 105).

In some embodiments, the server 110 might be a HTTP server, and to establish a call between the caller and the callee, without translation to a secondary protocol, the HTTP server might receive a first notification (from a browser of a first device associated with a caller) indicating an incoming call (either video or voice call). The HTTP server might send a second notification (either the same notification as the first notification or a new/separate notification based on the first notification, or the like) to the callee indicating the incoming call. The HTTP server might then relay (all) control information and data to establish the call between the caller and the callee. In some embodiments, control information and/or data that may be relayed to establish the call might include, without limitation, IP addresses and ports to which the actual audio and video data should be streamed for each user, resolution, aspect ratio, data rate capabilities, audio codecs supported, video codecs supported, encryption settings, and/or the like. In some instances, the HTTP might route traffic over a content delivery network (“CDN”). One goal of routing traffic over a CDN is to improve call quality, which might be achieved, e.g., by minimizing latency, reducing packet drops, and/or the like.

According to some embodiments, rather than relaying, non-relay routing or direct routing may be implemented. In such cases, the HTTP server might, similar to the embodiments with relaying, receive a first notification (from a browser of a first device associated with a caller) indicating an incoming call (either video or voice call), and might send a second notification (either the same notification as the first notification or a new/separate notification based on the first notification, and/or the like) to the callee indicating the incoming call. The HTTP server might subsequently provide, to each of the first device (e.g., user device 105a) associated with the caller and a second device (e.g., user device 105b) associated with the callee, at least one of the caller address, the callee address, or control information and data. A call between the caller and the callee may then be established (e.g., by the HTTP server), by streaming the control information and data from each of the first device and the second device to the other of the first device and the second device.

For handling incoming calls, a problem arises in that web browsers are not always running. Further, web browsers have historically had client/server relationships where the client requests information and the server provides it. This is problematic when the server would like to notify the user of an incoming call. The following non-limiting embodiments are directed to allowing the user to always be able to receive an incoming call, and ensures that when there is an incoming call that the user is notified independent of whether or not the user's browser was previously running (at the time the incoming call is received).

In some embodiments, the control server 110 might maintain a connection between the control server 110 and a user device (e.g., user device 105) associated with the user (i.e., potential callee), and might wake a browser (e.g., a web browser or the like) that is running on the user device in response to receiving a notification of an incoming call. In some cases, maintaining the connection between the control server 110 and the user device 105 might comprise associating the user device 105 with the control server 110, authenticating an identity of the user through the user device 105, and maintaining the connection based at least in part on the association and the authentication. In some instances, waking the browser might comprise the control server 110 waking the browser using a side communications channel between the control server 110 and the user device 105. According to some embodiments, waking the browser might comprise the control server 110 waking all browsers running on all user devices associated the user.

According to various embodiments, system 100 may also allow and facilitate establishment calls involving three or more parties or call participants (herein referred to as “multi-party calls”). In some embodiments, the control server 110 might receive, during a call between a caller and a callee, a request to establish a multi-party call with at least one additional call participant, the at least one additional call participant being separate from both the caller and the callee. The control server 110 might subsequently establish a multi-party call connecting the caller, the callee, and each of the at least one additional call participant.

In some cases, the request to establish the multi-party call might include a request to join the call that is received from the at least one additional call participant, in which case establishing the multi-party call comprises the control server 110 sending a notification to each of the caller and the callee indicating the request to join the call that is received from the at least one additional call participant, receiving, from one of the caller or the callee, instructions indicating acceptance of the at least one additional call participant in joining the call, and establishing a multi-party call connecting the caller, the callee, and each of the at least one additional call participant, in response to receiving the instructions indicating acceptance of the at least one additional call participant in joining the call.

In some instances, the request to establish the multi-party call might include a request, from one of the caller or the callee, to add the at least one additional call participant to the call. In such a case, establishing the multi-party call might comprise the control server 110 establishing a multi-party call connecting the caller, the callee, and each of the at least one additional call participant, in response to receiving the request to add the at least one additional call participant to the call.

According to some embodiments, establishing a multi-party call connecting the caller, the callee, and each of the at least one additional call participant might comprise seamlessly transferring the multi-party call to a conferencing server 135. In a non-limiting example, party A and party B might be in a call. One or both parties might want to add party C to the call. A conferencing server, which might be set up in the cloud, might serve to accommodate or establish the multi-party call. In some cases, all three users (i.e., parties A, B, and C) might call into the conferencing server. This may be transparent to one or more of the users. Party A and party B may maintain their current direct call. Alternatively, there may be some connecting graphic on the screen of a communication device of one or both parties while the conference server sets up the multi-party call, and a user (or both users) can follow a link or otherwise execute a set of instructions associated with interacting with the connecting graphic to connect to the multi-party call. From the perspective party C, party C might likely simply see that the call is connecting, and may be unaware of the processes through which the conferencing server might implement.

Now, as users connect to the conferencing server, there may be at least two other options: (a) as soon as a user connects to the conferencing server, video from the conference call might be shown; and (b) the server (and/or user devices) might wait until all users are connected to the conferencing server to show the video from the conference call. In case (a), a quick transition might result, but it can be strange to be the only one connected to the multi-party call established by the server. It is like being in a call by yourself. Thus, case (b) might be preferred in some or most situations. In this case, all user devices are caused to wait until all parties connect to the server, and then the devices display the video and present the audio from the multi-party call from the server. Thus, in case (b), the server may need to signal the number and/or identities of the parties to be connected to the multi-party call. Further, there may be an intermediate option (referred to herein as “case (c)”). In this option, the video and audio from the server (for the multi-party call) might be displayed or otherwise presented when at least N parties are connected, where N may be chosen to be 2 or 3. This ensures that when the multi-party portion of the call begins, there are in fact multiple parties in the call, although it may not be all of the parties that will ultimately join the call. In case (c), the conferencing server might typically be responsible for adding the additional parties as they successfully connect. Although the various examples above are directed to video calls, such examples are merely for purposes of illustration, and the various examples above may be similarly applicable to voice calls and/or other forms of communication involving multiple parties.

The conferencing server might perform processing for multiple callers, including performing aggregation and transcoding functions. In a non-limiting example of a three-party call, the conferencing server might need to first aggregate audio and video streams in order to establish/maintain the multi-party call. Consider, for example, that parties A, B, and C are on the call. Party C needs to be sent the combined audio from Party A and Party B. Party B needs the combined audio from Party A and Party C. This is a form of audio aggregation. Further, Party/user A only wants to see the video of Party B and Party C. There is no need to see himself or herself, of if he or she does want to see himself or herself it should be done locally as an overlay, because otherwise the latency would be noticeable (and bad). Further, the server may even change the layout/aggregation of the audio and video based on who is talking and/or moving. For example, if the screen layout has one position larger than the other, the server might put the user who is talking (i.e., with stronger audio) and/or moving (i.e., with more motion in the video) in the larger area of the screen. This may not be so simple, because that user who is talking may still not want to see himself or herself. Further, the aggregation may include displaying all users or only a subset of users. In an example where there are 20 people on the call, the server may opt to just display a maximum of n people (for example, 6 people, etc.) on the screen.

In terms of transcoding, it may be the case that the endpoints might have different data rate, audio codec, video codec, aspect ratio capabilities, and/or the like. The conferencing server is responsible for not only aggregating the streams, but also converting (or transcoding) the audio and video from one format to another. In a non-limiting example, the device of user A might support h.264, while the device of user B might support VP8. The conferencing server must receive h.264 from user A, but it must send VP8 to user B, and vice versa. Thus, the conferencing server must take the video stream from user A and convert or transcode from h.264 to VP8. In some cases, the conferencing server could in fact receive multiple video formats, aggregate them into the proper screen layout and transmit them in yet another video format (or, in some instances, at least a single, common video format, regardless of whether or not any of the video formats received is the same as the common video format). Although the various examples above are directed to video, such examples are merely for purposes of illustration, and the various examples above may be similarly applicable to audio and/or other similar information as well.

In some cases, conferencing server 135 might otherwise perform the functionalities of control server 110 that are described in detail above. In some instances, database 140 might store, locally, data and information that is stored in cloud storage system 130 that is useful or important for establishing and/or maintaining a multi-party call. In some embodiments, rather than establishing a multi-party call amongst three or more user devices over network 115, conferencing server 135 might establish a multi-party call amongst three or more user devices over network 115, over network 150, or over a combination of networks 115 and 150. For example, a connection between conferencing server 135 and each of one or more of a first user device 105a, a second device 105b, or a third device 105c might be over network 115, while connections between the conferencing server 135 and each of another of the one or more of the first user device 105a, the second device 105b, or the third device 105c c might be over network 150, and/or the like. In one example, the first user device 105a and the second device 105b might connect with the conferencing server 135 over network 115, while the third user device 105c might connect with the conferencing server 135 over network 150, or vice versa.

In some embodiments, the control server 110 might receive, during a call between a caller and a callee, a request from an additional caller to call one of the caller or the callee, the additional caller being separate from both the caller and the callee. In response to receiving an “ignore call” user input response from the one of the caller or the callee, control server 110 might prevent establishment of a call connection between the additional caller and the one of the caller or the callee, without interrupting the first call. In response to receiving a “switch call” user input response from the one of the caller or the callee, control server 110 might put the first call on hold and establishing a second call between the additional caller and the one of the one of the caller or the callee. In response to the second call ending, control server 110 might automatically (i.e., without user interaction) cause the first call to resume. In some cases, in response to receiving an “end call” user input response from the one of the caller or the callee to end the second call, the control server 110 might automatically (i.e., without further user interaction) cause the first call to resume (in some cases, prior to the second call being completely ended).

Merely by way of example, in some aspects, the control server 110 can provide a user interface (which can be used by users of the video calling devices 105 and/or the user devices 105, and/or the like). The control server 110 might also provide machine-to-machine interfaces, such as application programming interfaces (“APIs”), data exchange protocols, and the like, which can allow for automated communications with the video calling devices 105 and/or the user devices 105, etc. In one aspect, the control server 110 might be in communication with a web server 125 and/or might incorporate the web server 125, which can provide the user interface, e.g., over the network to a user computer (not shown in FIG. 1) and/or a machine-to-machine interface.

In another aspect, the control server 110 might provide such interfaces directly without need for a web server 125. Under either configuration, the control server 110 provides the user interface 120, as that phrase is used in this document. In some cases, some or all of the functionality of the control server 110 might be implemented by the video calling device 105 and/or the user device 105 itself.

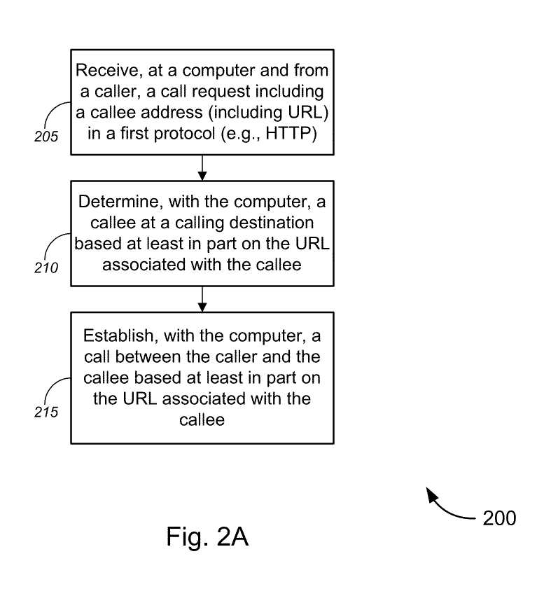

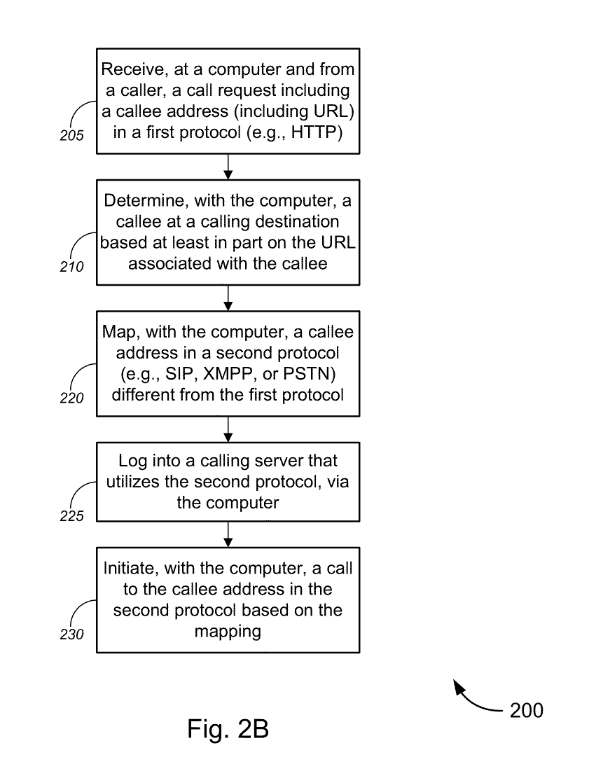

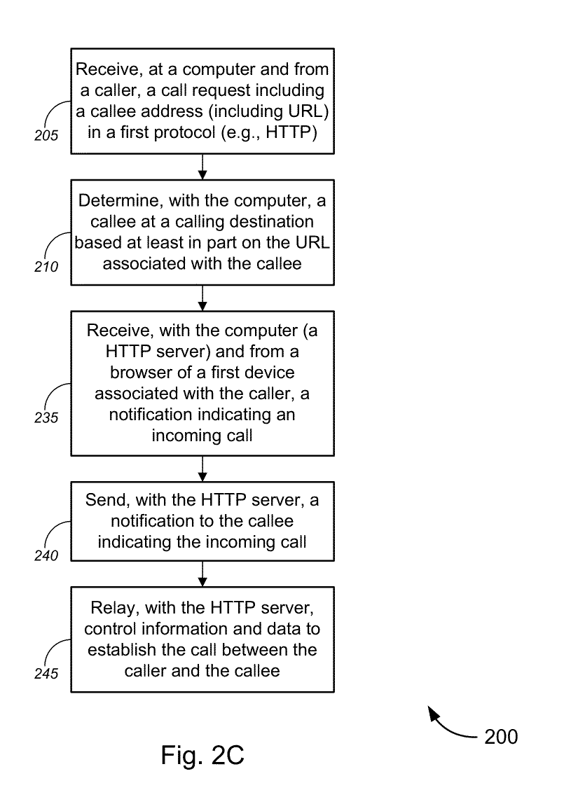

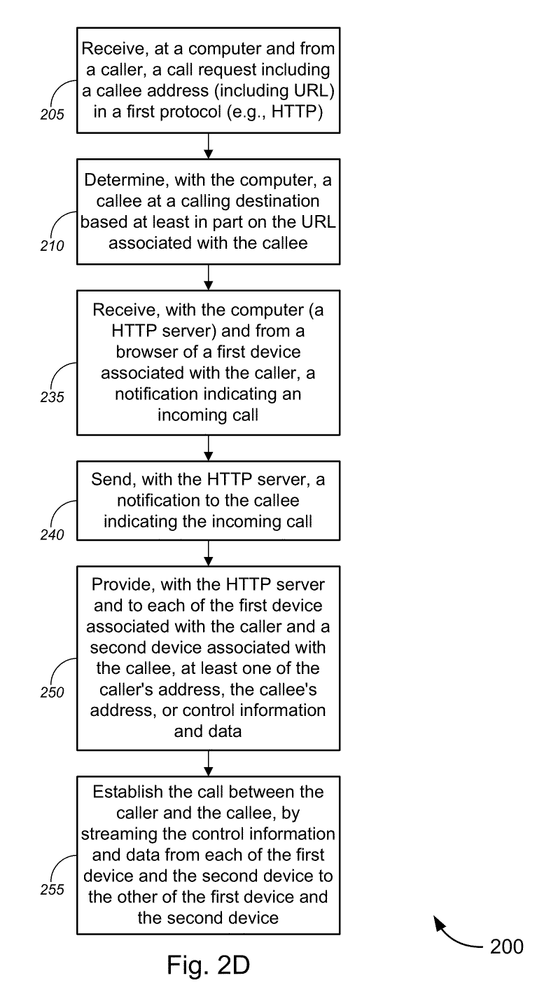

In operation, server 110 might perform the methods described in detail with respect to FIGS. 2-6 below, while data associated with user account(s) or preferences and/or data associated user calling addresses might be collected by the one or more user devices 105, by server 110, by server 135, or by any combination of these computing devices. The database 130 (and/or database 140) might store some or all of these collected data.

Aside from the video calling and conference addressing functionalities described above, the user devices 105, control server 110, and other components of system 100 may possess other functionalities and operations, which are described in greater detail in the Related Applications, and briefly mentioned below.

In some embodiments, the control server 110 can detect user presence, identify/authenticate users, and/or enable the user to remotely access the user's master account, user preferences, videomail messages, and/or the like. In other cases, the control server 110 can receive and/or store user input and/or user preferences that can specify whether and how presence information should be used, whether and how the user's video calling device(s) and/or user device(s) may be used in the distributed infrastructure, whether and how the user's content and profiles should be handled under certain situations, and/or the like.

For example, preferences might specify which account information, content, profile information, personal communications (e.g., videomail, etc.), and/or the like should be delivered to a user when present at a device not owned by the user, whether presence information should be collected for that user at all (and/or where such information should be collected); for example, a user might specify that his presence should only be monitored in selected locations or from selected devices, and the control server 110 might remove that user's profile from the search universe when provided with presence information from a device not at the selected location or from a device other than one of the selected devices. More generally, the user preference can include any types of parameters related to collecting presence information, using presence information, and/or serving content/information (including, without limitation, user account information, user content, user profile information, user's personal communications (e.g., videomail, etc.), and/or the like). These preferences might be stored in a user profile at the control server 110, which might also include other user-specific information, such as the user's normal location(s), identifying information (such as MAC address, etc.) of other user devices owned by or associated with the user, lists of or links to content owned by the user, lists of or links to videomail messages addressed to the user, and/or the like. Videomail capture, processing, and distribution is described in greater detail in the '499 and '621 applications (already incorporated herein).

In some aspects, a plurality of video calling devices 105 might be communicatively coupled together in a network (e.g., network 115), each video calling device being located in one of a plurality of customer premises. For implementing distributed infrastructure for cloud computing, cloud-based application hosting, and/or cloud-based data storage, a computer might establish one or more video calling devices 105 of the plurality of video calling devices 105 as distributed infrastructure elements and might provide at least one of one or more software applications, customer data, and/or media content to the one or more video calling devices 105 for hosting on the one or more video calling devices 105. These and other functionalities of the video calling devices related to distributed infrastructure are described in greater detail in the '360 application (already incorporated by reference herein).

In some embodiments, user preferences might specify how the user would like his or her user devices to participate (or not) in a distributed infrastructure arrangement. For instance, the user preferences might include, without limitation, preferences indicating whether or not to allow a user device owned by the user to be used for distributed infrastructure; preferences indicating what type of software applications, customer data, and/or media content (of other user device users and/or subscribers of a cloud service) are permitted to be hosted on a user device owned by the user; and/or preferences indicating amount of resources of a user device to dedicate to the distributed infrastructure; etc. In some embodiments, in addition to indicating how a user's user device may be used in distributed infrastructure implementation, user preferences might allow a user to indicate how the user's own applications, data, and/or media content may be hosted on other users' user devices. For example, the user might be given the option to encrypt any and/or all personal data, any and/or all personal applications, any and/or all files or lists indicating which media content are associated with the user, and/or any and/or all files or lists pertaining to videomail messages that are addressed to the user (including the videomail messages themselves). Common media content (which might include popular media content, or any other media content) may remain unencrypted for common usage by any number of users on any number of user devices, subject only to any subscription, rental, or purchase restrictions on the particular media content as associated with any user and/or any user device. On the other hand, the user's personal communications (including, e.g., videomail messages and/or the like) may be encrypted.

In some examples, the user might indicate that her user device may be used for distributed processing, but not distributed cloud-based data storage, or vice versa. Alternatively, the user might indicate that her user device may be used for both distributed processing and distributed cloud-based data storage. In some embodiments, the user might allow the hosting, on his or her user device, of at least portions of software applications that are published by known and reputable software companies or published by companies on behalf of governmental agencies, or the like, while blocking hosting of software applications associated with marketing, spam, data mining, and/or potential copyright violations, etc. These and other preferences related to distributed infrastructure functionality, as well as distributed infrastructure implementation of user devices, are described in greater detail in the '360 application (which is already incorporated herein by reference).

In one aspect of certain embodiments, as described in the Related Applications, a video calling device 105 or a user device 105 can be placed functionally inline between a local content source and a display device. A local content source can be any device that provides an audio or video stream to a display device and thus can include, without limitation, a cable or satellite set-top box (“STB”), an Internet Protocol television (“IPTV”) STB, devices that generate video and/or audio, and/or acquire video and/or audio from other sources, such as the Internet, and provide that video/audio to a display device; hence, a local content source can include devices such as a video game console, a Roku® streaming media player, an AppleTV®, and/or the like. When situated functionally inline between a local content source and a display device, the video calling device or the user device can receive an audiovisual stream output from the local content source, modify that audiovisual stream in accordance with the methods described herein, in the '182 patent, and/or in the '279 application, and provide the (perhaps modified) audiovisual stream as input to the display device. It should be noted, however, that, in some cases, the functionality of a local content source can be incorporated within a video calling device or a user device, and/or the functionality of a video calling device or a user device can be incorporated within a local content source; further, it should be appreciated that a video calling device or a user device (which might or might not include local content source functionality) can be disposed inline with one or more other local content sources or one or more other video calling devices/user devices. Hence, for example, a video calling device or a user device with some local content source functionality (such as a video game console) might be disposed inline between one or more other local content sources or one or more other video calling devices/user devices (such as a cable STB, satellite STB, IPTV STB, and/or a streaming media player) and a display device.

In an aspect of some embodiments, the system can include a software client that can be installed on a computing device (e.g., a laptop computer, wireless phone, tablet computer, etc.) that has a built-in camera and/or has a camera attached (e.g., a USB webcam). This client can act as an interface to allow remote control of the built-in and/or attached camera on the computing device. In some embodiments, the computing device might have a built-in microphone(s) and/or has a microphone(s) attached (e.g., a table-top microphone, a wall-mounted microphone, and/or a microphone removably mountable on a television, on the video calling device, on the user device, and/or on some other suitable user device, or the like). The software client can alternatively and/or additionally act as an interface to allow remote control of the built-in and/or attached microphone on the computing device. In some cases, the camera and/or microphone can be automatically or autonomously controlled to obtain optimal video and/or audio input. Remote control of the video calling device and/or user device is described in detail in the '263 application (already incorporated herein).

In an aspect, the user interface 120 allows users to interact with the control server 110, and by extension, the video calling devices 105 and/or the user devices 105. A variety of user interfaces may be provided in accordance with various embodiments, including, without limitation, graphical user interfaces that display, for a user, display fields on display screens for providing information to the user and/or receiving user input from a user. Example graphical user interfaces are shown in FIG. 6 as described below.

Merely by way of example, in some embodiments, the control server 110 may be configured to communicate with a user computer (not shown in FIG. 1) via a dedicated application running on the user computer; in this situation, the user interface 120 might be displayed by the user computer based on data and/or instructions provided by the control server 110. In this situation, providing the user interface might comprise providing instructions and/or data to cause the user computer to display the user interface. In other embodiments, the user interface may be provided from a web site, e.g., by providing a set of one or more web pages, which might be displayed in a web browser running on the user computer and/or might be served by the web server 125. As noted above, in various embodiments, the control system 110 might comprise the web server and/or be in communication with the web server 125, such that the control server 110 provides data to the web server 125 to be incorporated in web pages served by the web server 125 for reception and/or display by a browser at the user computer.

The network 115 (or network 150), specific examples of which are described below with regard to FIG. 8, can be any network, wired or wireless, that is capable of providing communication between the control server 110 and the video calling devices 105 and/or the user devices 105, and/or of providing communication between the control server 110 (and/or the web server 125) and a user computer. In a specific embodiment, the network 115 (or network 150) can comprise the Internet, and/or any Internet service provider (“ISP”) access networks that provide Internet access to the control server 110, the user computer, and/or the video calling devices 105 and/or the user devices 105.

In some embodiments, the system 100 can include a cloud storage system 130, which can be used, as described in further detail below, to store user addresses in at least one protocol (e.g. HTTP, SIP, XMPP, PSTN protocol, etc.); user preferences regarding call conferencing, conference addressing, etc.; and/or the like. In some instances, the cloud storage system 130 might further store advertisements, presence information, images, video, and/or videomail messages that are captured and uploaded by the video calling devices 105 and/or the user devices 105, and/or the like.

In some cases, the cloud storage system 130 might be a proprietary system operated by an operator of the control server 110. In other cases, the cloud storage system 130 might be operated by a third party provider, such as one of the many providers of commercially available cloud services. In yet a further embodiment, the cloud storage system 130 might be implemented by using resources (e.g., compute, memory, storage network, etc.) shared by a plurality of video calling devices, and/or by a plurality of user devices, that are distributed among various users of the system. Merely by way of example, as described in further detail below and in the '360 application (already incorporated by reference herein), a plurality of user video calling devices and/or user devices might each have some dedicated resources (such as a storage partition), which are dedicated for use by the system, and/or some ad hoc resources (such as network bandwidth, memory, compute resources, etc.) that are available to the system when not in use by a user. Such resources can be used as cloud storage and/or can be used to provide a distributed, cloud-like platform on which a control server can run as a virtual machine, cloud container, and/or the like.

According to some embodiments, video calling device 105 might comprise a first video input interface to receive first video input from a first local content source (which in some embodiments can include a STB and/or the like) and a first audio input interface to receive first audio input from the first local content source. Video calling device 105 might further comprise a first video output interface to provide first video output to a first video display device and a first audio output interface to provide first audio output to a first audio receiver. In some cases, the first video display device and the first audio receiver might be embodied in the same device (e.g., a TV with built-in speaker system, or the like). With the input and output interfaces, video calling device 105 might provide pass-through capability for video and/or audio between the first local content source and the first display device. In some instances, high-definition multimedia interface (“HDMI”) cables or other suitable HD signal cables may be used to provide the interconnections for the pass-through. Video calling device 105 may, in some cases, comprise a first video capture device to capture at least one of first image data or first video data and a first audio capture device to capture first audio data. Video calling device 105 may also comprise a first network interface, at least one first processor, and a first storage medium in communication with the at least one first processor.

Merely by way of example, in some aspects, a user can remotely access one or more video calling devices 105 and/or remotely access at least one of the user's master account, the user's user preference, the user's profiles, any videomail messages addressed to the user, and/or the like over a network. For example, in a web-based implementation, a user could log into the user's master account by accessing a website hosted on a web server (e.g., web server 125, which might be hosted on a cloud server, hosted on distributed user devices, hosted on distributed video calling devices, and/or the like) and entering commands into a user interface (e.g., user interface 120) associated with remotely accessing the user's video calling device(s) 105 and/or associated with remotely accessing at least one of the user's master account, the user's user preference, the user's profiles, any videomail messages addressed to the user, and/or the like. In some instances, the user might access and interact with the user interface over the network (e.g., network 115) by using a user computer selected from a group consisting of a laptop computer, a desktop computer, a tablet computer, a smart phone, a mobile phone, a portable computing device, and/or the like. In an application-based (or “app-based”) implementation, the user might interact with a software application (or “app”) running on the user's user device, which might include, without limitation, a laptop computer, a desktop computer, a tablet computer, a smart phone, a mobile phone, a portable computing device, and/or the like. The app might include another user interface (similar to the web-based user interface) that might allow for access of the user's video calling device(s) (or any paired video calling device(s)) over the network (e.g., network 115) and/or that might allow for access to at least one of the user's master account, the user's user preference, the user's profiles, any videomail messages addressed to the user, and/or the like.

In some embodiments, access of one or more video calling device(s) and/or access to at least one of the user's master account, the user's user preference, the user's profiles, any videomail messages addressed to the user, and/or the like may be permitted in response to identification and/or authentication of the user by a presence detection device (“PDD”), as described in detail herein and in the '279 application. In some embodiments, a user device 105 might comprise a second video input interface to receive second video input from a second local content source (which, in some embodiments, might include a STB and/or the like) and a second audio input interface to receive second audio input from the second local content source. User device 105 might further comprise a second video output interface to provide second video output to a second video display device and a second audio output interface to provide second audio output to a second audio receiver. In some cases (as with video calling device 105 or user device 105 above), the second video display device and the second audio receiver might be embodied in the same device (e.g., a TV with built-in speaker system, or the like). With the input and output interfaces, user device 105 might provide pass-through capability for video and/or audio between the second local content source and the second display device. In some instances, high-definition multimedia interface (“HDMI”) cables or other suitable HD signal cables may be used to provide the interconnections for the pass-through. User device 105 may, in some cases, comprise a second video capture device to capture at least one of second image data or second video data, and a second audio capture device to capture second audio data. user device 105 might also comprise a second network interface, at least one second processor, and a second storage medium in communication with the at least one second processor. Similar to the video calling devices 105, a plurality of user devices 105 may be communicatively coupled together in a network (e.g., network 115), as distributed infrastructure elements for implementing distributed infrastructure for cloud computing, cloud-based application hosting, and/or cloud-based data storage.

Once a user has been automatically identified and/or authenticated by a user device having identification and/or authentication functionality (e.g., by a PDD as described herein or as described in the '279 application), regardless of whether or not the user is associated with (or owns) such user device, the user may be provided with access to the video calling device(s) over the network and/or remote access to at least one of the user's master account, the user's user preference, the user's profiles, any videomail messages addressed to the user, and/or the like. Such access (as discussed above) may be in the form of web-based user interfaces, app-based user interfaces, or other suitable user interfaces. Such user interfaces might be customized automatically based on the user preferences (i.e., based on the video mail capture, processing, and distribution user preferences discussed above). In some instances, the user interfaces might be configured to allow addition, modification, and/or deletion of such user preferences. According to some embodiments, the user interfaces might provide the user with options for uploading, locally storing, cloud storing, distributing/sharing, processing, and/or otherwise handling recorded videomail messages from the video calling device(s). Some of these options may be preselected (or established as default settings) in the user preferences. In some cases, processing of videomail messages from the video calling device(s) might include, without limitation, formatting, sharpening, and/or otherwise manipulating the videomail messages.

In some cases, the user device (e.g., PDD) might be configured to determine whether the user is no longer present. Based on such a determination, access to the video calling device(s) over the network, as well as access to at least one (if not all) of the user's master account, the user's user preference, the user's profiles, any videomail messages addressed to the user (whether in the raw or processed state), and/or the like, may be blocked. Blocking such access may include automatically logging out of the web-based or app-based user interface, or the like.

These and other functionalities are described in detail in the Related Applications.

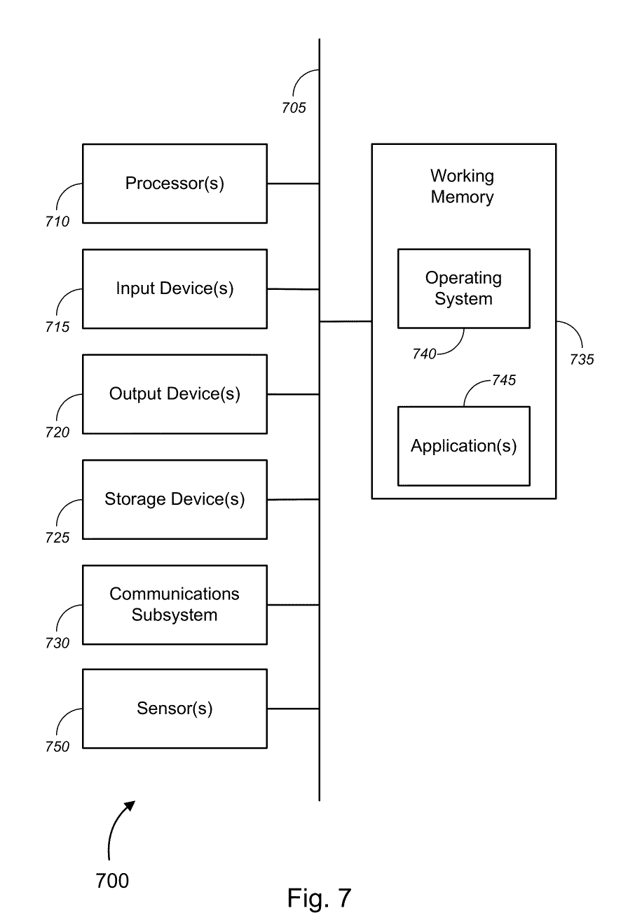

FIGS. 2A-2D (collectively, “FIG. 2”) illustrate various methods 200 of enabling or implementing video or voice calling and conferencing addressing, in accordance with one set of embodiments. FIG. 2A illustrates a general method, while each of FIGS. 2B-2D illustrates various alternative specific, non-limiting examples of implementations of the method. While the techniques and procedures are depicted and/or described in a certain order for purposes of illustration, it should be appreciated that certain procedures may be reordered and/or omitted within the scope of various embodiments. Moreover, while the method illustrated by FIG. 2 can be implemented by (and, in some cases, are described below with respect to) the systems 100, 700, and/or 800 of FIGS. 1, 7, and/or 8, respectively (or components thereof), such methods may also be implemented using any suitable hardware implementation. Similarly, while each of the system 100 (and/or components thereof) of FIG. 1, the system 700 (and/or components thereof) of FIG. 7, and/or the system 800 (and/or components thereof) of FIG. 8 can operate according to the method illustrated by FIG. 2 (e.g., by executing instructions embodied on a computer readable medium), the system 100 can also operate according to other modes of operation and/or perform other suitable procedures.

With reference to FIG. 2A, at block 205, method 200 might comprise receiving, at a computer and from a caller, a call request including a callee address in a first protocol. In some embodiments, the first protocol might be hypertext transfer protocol (“HTTP”), and the callee address might include a uniform resource locator (“URL”) associated with the callee. In some cases, the URL associated with the callee might be a URL associated with at least one device associated with the callee. According to some embodiments, the computer might be a server located over a network (e.g., server 110 or 125 over network 115, with respect to user device 105, shown in FIG. 1). In some instances, the caller sending the call request might include the caller entering, clicking, following, or executing the URL associated with the callee.

Merely by way of example, in some aspects, at the caller end, appropriate plugins might be downloaded and installed, if needed, and the caller might (optionally) be prompted for user information (or user information might be accessed), which might include name, e-mail address, caller address, avatar, and/or the like. If the user information is entered, such information may be stored locally on the user device or at a server over a network, such that the entry is not required on subsequent calls.

Method 200, at block 210, might comprise determining, with the computer, a callee at a calling destination based at least in part on the URL associated with the callee. Merely by way of example, in some aspects, determining a callee at a calling destination might include, without limitation, performing a database lookup to determine address (and, in some cases, to determine a protocol) to be used to call the callee, based at least in part on the URL.

Method 200 might further comprise establishing, with the computer, a call between the caller and the callee based at least in part on the URL associated with the callee (block 215). In some embodiments, the call might be a video call. In other embodiments, the call might be one of a voice call, an e-mail communication, a text communication (e.g., short message service (“SMS”) communication, chat communication, etc.), multimedia communication (e.g., multimedia messaging service (“MMS”) communication, etc.), or the like. In placing the call (in some cases, using the appropriate protocol and address determined in block 210), some negotiation processes might take place. Herein, negotiation might include, but is not limited to, negotiating routing, negotiating video on/off (for video calls), negotiating video bandwidth, resolution, and codec type (also for video calls), negotiating audio bandwidth, data rate, and codec type (for video and voice calls), and/or the like.

In some embodiments, the computer might be a user device associated with the caller, while in some cases, the computer might be a server over a network. In the case that the computer is the user device associated with the caller, the process of establishing, with the computer, a call between the caller and the callee based at least in part on the URL associated with the callee (at block 215) might comprise establishing a call by sending a request to the server over the network to establish the call between the caller and the callee based at least in part on the URL associated with the callee, with the server performing the process of establishing the call. According to some embodiments, determining a callee at a destination based at least in part on the URL associated with the callee might be performed at the user device associated with the caller and/or at the server. In the case of the computer being the user device associated with the caller, the determining process (at block 210) might include either determining a callee at a destination by directly querying a database (which might be local to the user device or located over a network) or determining a callee at a destination by sending a request for a server to determine a callee at a destination.

Regarding FIGS. 2B-2D, the processes at blocks 205 and 210 of FIG. 2A might be the same or similar, but the process of establishing the call between the caller and the callee in block 215 might differ and might comprise sub-processes, as described below.

FIG. 2B illustrates a method that involves address translation from a first protocol (e.g., HTTP) to a second protocol different from the first protocol. In some embodiments, the second protocol (which is different from the first protocol) might include, without limitation, session initiation protocol (“SIP”), extensible messaging and presence protocol (“XMPP”), public switched telephone network (“PSTN”) protocol, and/or the like. In the embodiment of FIG. 2B, the process of establishing the call of block 215 (referred to herein as “call establishment with mapping”), which involves address translation, might comprise mapping, with the computer, a callee address in a second protocol different from the first protocol (block 220), logging into a calling server that utilizes the second protocol, via the computer (block 225), and initiating, with the computer, a call to the callee address in the second protocol based on the mapping (block 230).

In the case of the second protocol being SIP, the callee address might include a SIP address associated with the callee and/or with one or more devices associated with the callee. For XMPP as the second protocol, the callee address might include an XMPP address associated with the callee and/or with one or more devices associated with the callee. Such an XMPP address—which might otherwise be referred to by those of skill in the art as a Jabber ID or JID—might, in some instances, include a username and one of a domain name or an Internet protocol (“IP”) address. When the second protocol is PSTN, the callee address might include a telephone number associated with the callee and/or with one or more devices associated with the callee. In some cases, mapping a callee address in the second protocol might include translating the URL into one of a SIP address, a JID, a telephone number, and/or the like.

In a non-limiting example of method 200 with call establishment with mapping, a computer or server (e.g., control server 110 and/or web server 125 of FIG. 1) might receive a call request from a caller. The call request might be in HTTP, and might include a callee address including a URL associated with the callee (e.g., “http://johndoe.name”) or a URL associated with a device associated with the callee (e.g., “http://mobilel.johndoe.name”), and/or the like. Other examples of URLs might include, without limitation, ones including domain names of a service provider (e.g., “http://biscotti.com/call/johndoe”), ones including a commercial (or more accurately, though not widely referred to, “common”) domain name associated with the callee (e.g., “http://johndoe.com” or “http://www.anotherdomain.com/johndoe/”), and/or the like. The computer or server might subsequently search or query a database(s) (whether internal or external, within a local area network or accessible over another network (e.g., the Internet or the like)) to determine a callee at a calling destination, based at least in part on the URL. In other words, the computer or server might determine, from a search of the database(s), either an identity of a callee, an identity of a calling destination (e.g., device or location associated with the callee and/or URL), identification information of one or more devices associated with the user, and/or the like, each based (at least in part) on the URL.

Once the callee, the calling destination, and/or the one or more devices associated with the callee have been identified, the computer or server might map the URL in a second protocol. For example, the computer or server might map the URL into SIP (e.g., “SIP:johndoe@anotherdomain.com”; “SIP:jdoe@biscotti.com”; and/or the like), XMPP (e.g., “johndoe@yetanotherdomain.com”; “johndoe@biscotti.com/mobile”; “johndoe@domain.com/home”; and/or the like), PSTN protocol (e.g., “123-456-7890”). The computer or server might subsequently log into a calling server that utilizes the second protocol (e.g., a SIP calling server (e.g., VoIP service or the like), a calling server utilizing XMPP, a calling service that utilizes time division multiplex (“TDM”) or other PSTN formats, and/or the like), and might automatically initiate or establish a call to the callee address in the second protocol based on the mapping, via the calling server. In some embodiments, the call might be initiated by using port 80, which is used by HTTP, and which is commonly open by default by most firewalls and/or routers.

FIGS. 2C and 2D illustrate methods that do not involve address translation. In other words, these embodiments use web addresses for calling, but do not translate to a secondary protocol such as SIP, XMPP, PSTN, and/or the like. The web browser just connects to an HTTP server/address associated with a user. For example, the user might provide his address to the world as “http://matthew.com.” By following the link, anyone with a browser could call the user. The user, as a callee, might stay connected to his server all the time. A caller might connect to the server (via the web address) only when the caller wanted to call the user. In such cases, there would no longer be a need for PSTN. One intended benefit includes that this calling process can all be done over HTTP, which is never blocked by firewalls. Service providers can also offer the new service (i.e., a service whereby a user can tell the world that anyone can call the user at “user.org” or the like). The caller can place calls from any suitable device, including, but not limited to, a smartphone, a tablet computer, a laptop computer, a desktop computer, a video calling device, and/or the like.

In some implementations, as shown in the embodiment of FIG. 2C, the computer might be a HTTP server and the process of establishing the call of block 215 (referred to herein as “call establishment with relaying”) might comprise receiving, with the HTTP server and from a browser of a first device associated with the caller, a notification indicating an incoming call (block 235), sending, with the HTTP server, a notification to the callee indicating the incoming call (block 240), and relaying, with the HTTP server, control information and data to establish the call between the caller and the callee (block 245).

In a non-limiting example of method 200 with call establishment with relaying, a HTTP server (e.g., control server 110 and/or web server 125 of FIG. 1) might receive, from a caller, a call request in HTTP including a URL associated with the callee, a URL associated with a device associated with the callee, and/or the like, and might determine a callee at a calling destination based at least in part on the URL, as described in detail above. If the caller is using a tablet computer to send the call request, a browser running on the tablet computer might send a call notification to the HTTP server, which might receive the call notification and might send a notification to the callee indicating the incoming call. The HTTP server might provide to the tablet computer and to a user device associated with the callee (e.g., a smartphone, laptop computer, tablet computer, desktop computer, video calling device, or the like) at least one of the caller's address (e.g., URL), the callee's address (e.g., URL), and/or control information and data to establish the call between the caller and the callee. By relaying the information and data, the call can be established between the caller and the callee.

In an alternative implementation, as shown in the embodiment of FIG. 2D, the process of establishing the call of block 215 (referred to herein as “call establishment without relaying”) might comprise, in addition to the processes in blocks 235 and 240 of FIG. 2C, providing, with the HTTP server and to each of the first device associated with the caller and a second device associated with the callee, at least one of the caller address, the callee address, or control information and data used for establishing the call between the caller and the callee (block 250), and establishing the call between the caller and the callee, by streaming the control information and data from each of the first device and the second device to the other of the first device and the second device (block 255). In some embodiments, the call might be established by streaming the control information and data to an appropriate port (e.g., port 80) of each of the first and second devices. In some cases, control information may include information comprising, without limitation, maximum data rate(s) allowed, video codec(s) supported, audio codec(s) supported, video resolution(s) supported, open port(s), protocol(s) supported, device or display name, avatar or image for the user, and/or the like.

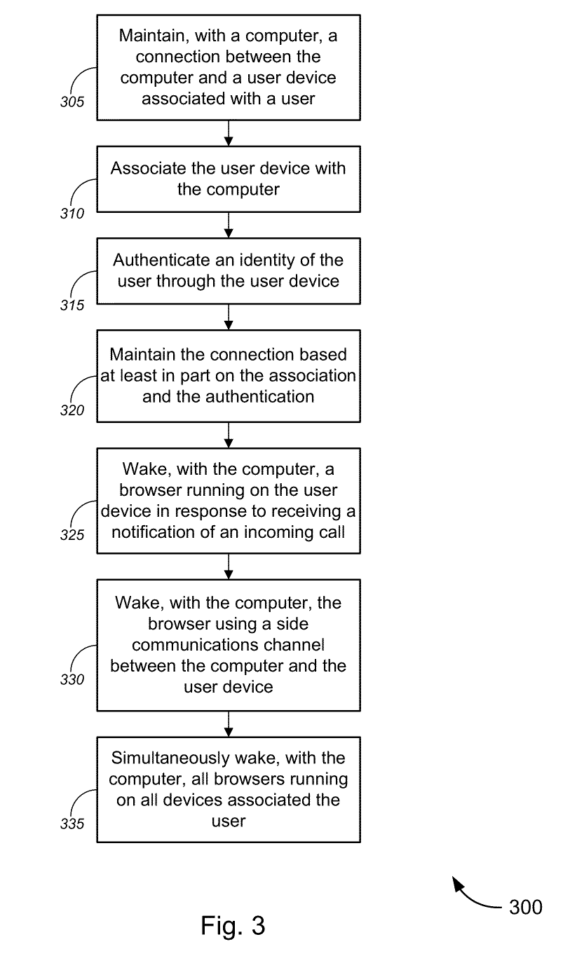

We now turn to FIG. 3, which is a process flow diagram illustrating a method 300 of waking one or more browsers running on one or more devices associated with a user in response to an incoming call, in accordance with various embodiments. While the techniques and procedures are depicted and/or described in a certain order for purposes of illustration, it should be appreciated that certain procedures may be reordered and/or omitted within the scope of various embodiments. Moreover, while the method illustrated by FIG. 3 can be implemented by (and, in some cases, are described below with respect to) the systems 100, 700, and/or 800 of FIGS. 1, 7, and/or 8, respectively (or components thereof), such methods may also be implemented using any suitable hardware implementation. Similarly, while each of the system 100 (and/or components thereof) of FIG. 1, the system 700 (and/or components thereof) of FIG. 7, and/or the system 800 (and/or components thereof) of FIG. 8 can operate according to the method illustrated by FIG. 3 (e.g., by executing instructions embodied on a computer readable medium), the system 100 can also operate according to other modes of operation and/or perform other suitable procedures. In some embodiments, method 300 might be implemented complementary to method 200 of FIG. 2, while in other embodiments, method 300 may be implemented independently, separately, or otherwise without implementing method 200.

Web browsers are not always running. This creates a problem for incoming calls that rely on web browsers or that are otherwise based on HTTP or the like. Further, web browsers have historically had client/server relationships where the client requests information, and the server provides it. This is problematic when the server would like to notify the user of an incoming call. The embodiments described below relate to always being able to receive an incoming call. Some of the embodiments described herein ensure that when there is an incoming call, the user is notified independent of whether or not his or her browser was previously running.

Method 300, at block 305, might comprise maintaining, with a computer, a connection between the computer and a user device associated with a user. According to some embodiments, the process of maintaining the connection (at block 305) might comprise associating the user device with the computer (block 310), authenticating an identity of the user through the user device (block 315), and maintaining the connection based at least in part on the association and the authentication (block 320). According to some embodiments, connections may be maintained using a TCP/IP connection, a WebSocket (“WS”) connection, and/or a HTTP connection, and in some cases, possibly with techniques including, but not limited to, long polling to keep the connection alive. Further, a persistent connection may be emulated by using polling techniques, which may use protocols including, without limitation, HTTP or TCP/IP connections. Although polling techniques may be used, in general, they tend to have more overhead, and thus non-polling-based approaches may be preferred in some situations. Persistent connections may also be achieved by using messaging protocols such as SIMPLE or XMPP. With regard to the use of WS connections, WS enables a bi-directional, persistent connection to the user device(s) (and/or browser(s) running on the user device(s)), without polling. In some cases, a WS connection might be thought of as a form of an upgraded HTTP connection. In fact, WS connections can start off as a HTTP connection and may then be upgraded to a full WS connection.

At block 325, method 300 might comprise waking, with the computer, a browser running on the user device in response to receiving a notification of an incoming call. In some embodiments, the process of waking the browser might comprise waking, with the computer, the browser using a side communications channel between the computer and the user device (block 330) and/or simultaneously waking, with the computer, all browsers running on all devices (including, but not limited to, smartphone, tablet computer, laptop computer, desktop computer, video calling device, and/or the like) that are associated the user (block 335). In terms of the function of waking browsers, in some embodiments, there might be two scenarios: in a first scenario, the browser might have been started (or might be running), while in the second scenario, the browse might not yet be started (or might not yet be running). If the browser has not yet started (i.e., second scenario), a message must be passed to the operating system to start the process, i.e., to start the browser. Exactly how this is done varies from operating system to operating system. In a Linux system, for example, the functions system( ), fork( ), and/or exec( ) may be used to start another application. In an Android system, the startActivity( ) function may be used. When starting the process, additional information (e.g., a URL) may be passed for the browser to open. In some cases, the browser process may already be active, and the browser just needs to follow the directive provided. In other cases, the browser process may also need to be started. Depending on the implementation, waking the browser to do work may be performed using inter-process communication techniques, including, but not limited to, shared memory, message passing, semaphores, pipes, etc.

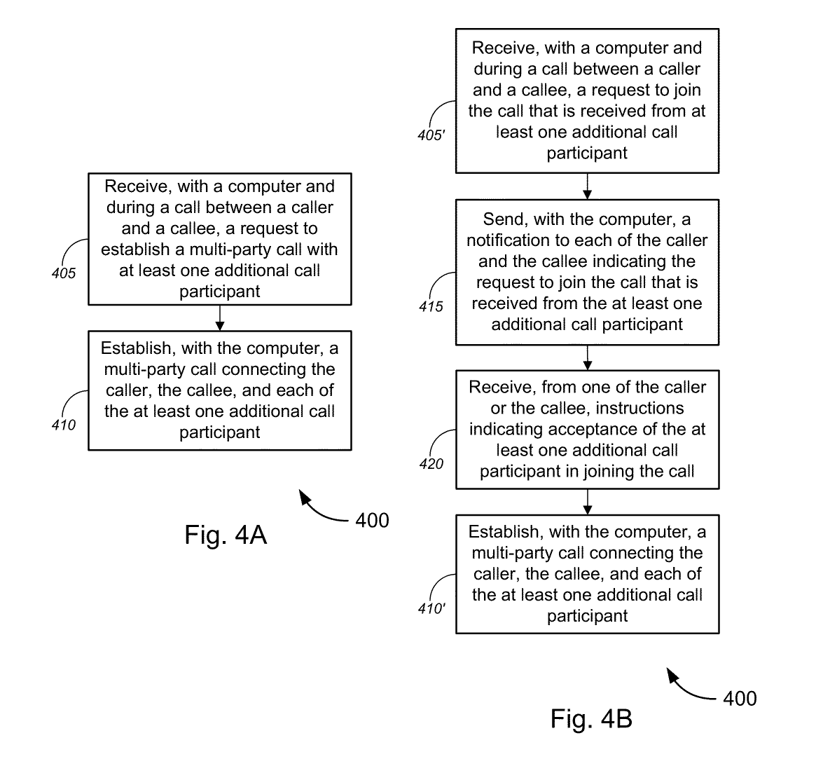

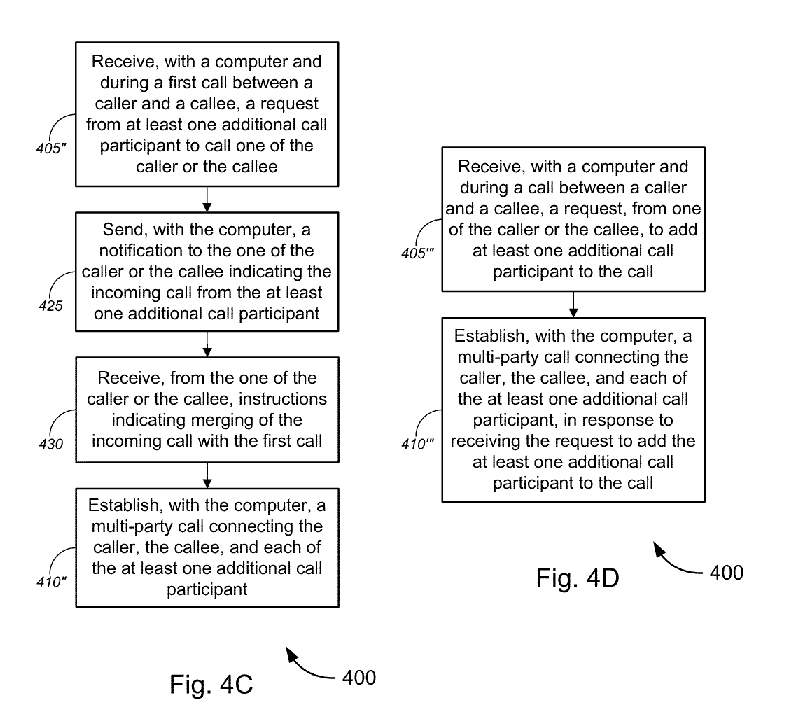

FIGS. 4A-4D (collectively, “FIG. 4”) are process flow diagrams illustrating various methods 400 of enabling, handling, or implementing multi-party calls, in accordance with various embodiments. While the techniques and procedures are depicted and/or described in a certain order for purposes of illustration, it should be appreciated that certain procedures may be reordered and/or omitted within the scope of various embodiments. Moreover, while the method illustrated by FIG. 4 can be implemented by (and, in some cases, are described below with respect to) the systems 100, 700, and/or 800 of FIGS. 1, 7, and/or 8, respectively (or components thereof), such methods may also be implemented using any suitable hardware implementation. Similarly, while each of the system 100 (and/or components thereof) of FIG. 1, the system 700 (and/or components thereof) of FIG. 7, and/or the system 800 (and/or components thereof) of FIG. 8 can operate according to the method illustrated by FIG. 4 (e.g., by executing instructions embodied on a computer readable medium), the system 100 can also operate according to other modes of operation and/or perform other suitable procedures. In some embodiments, method 400 might be implemented complementary to method 200 of FIG. 2 and/or method 300 of FIG. 3, while in other embodiments, method 400 may be implemented independently, separately, or otherwise without implementing method 200 and/or method 300.

Herein, a “multi-party call” refers to a call (simultaneously or concurrently) connecting three or more parties or call participants. In some embodiments, during an active call, additional call participants can be added in an ad-hoc manner, which might turn a two-party call into a multi-party call. In some cases, a button or link in a web browser interface, when depressed, clicked, or followed, allows a user (i.e., caller or callee) to invite additional participants to the call. In some cases, the additional call participants might each individually call the caller or callee, and another button or link in a web browser interface, when depressed, clicked, or followed, allows the user (i.e., caller or callee) to merge the incoming call from the additional participant(s) with the existing call to establish a multi-party call connecting the caller, the callee, and each of the additional participant(s). Although the above embodiments refer to a web browser interface, other user interfaces may be similarly implements; such other user interfaces might include, without limitation, an application (or “app”)-based user interface, a video calling graphical user interface, a voice calling graphical user interface, a virtual reality user interface, an augmented reality user interface, and/or the like.

In the embodiment of FIG. 4A, method 400, at block 405, might comprise receiving, with a computer and during the call between the caller and the callee, a request to establish a multi-party call with at least one additional call participant, the at least one additional call participant being separate from both the caller and the callee. The request might be received from an additional call participant(s), as described with respect to FIG. 4B (to join the existing call) or FIG. 4C (to call only one of the existing call participants, but open to joining the existing call), or from an existing call participant (i.e., a caller or callee), as described with respect to FIG. 4D. At block 410, method 400 might comprise establishing, with the computer, a multi-party call connecting the caller, the callee, and each of the at least one additional call participant. In some embodiments, additional call participant(s) may be added to an existing multi-party call, in a similar manner as described herein for adding additional call participant(s) to two-party calls.

With reference to FIG. 4B, method 400 might comprise receiving, with a computer and during a call between a caller and a callee, a request to join the call that is received from the at least one additional call participant (block 405′). Method 400, at block 415, might comprise sending, with the computer, a notification to each of the caller and the callee indicating the request to join the (existing) call that is received from the at least one additional call participant. At block 420, method 400 might comprise receiving, from one of the caller or the callee, instructions indicating acceptance of the at least one additional call participant in joining the call. In some cases, the instructions might include instructions associated with the one of the caller or the callee pressing, clicking, or following a button or link in a web browser, in a calling application (“app”), or in some other user interface. Method 400 might further comprise establishing, with the computer, a multi-party call connecting the caller, the callee, and each of the at least one additional call participant, in response to receiving the instructions indicating acceptance of the at least one additional call participant in joining the call (block 410′).

In an alternative, but similar, embodiment, which is shown in FIG. 4C, method 400 might comprise, at block 405″, receiving, with a computer and during first a call between a caller and a callee, a request from the at least one additional call participant to call one of the caller or callee. Method 400, at block 425, might comprise sending, with the computer, a notification to the one of the caller or the callee indicating the incoming call from the at least one additional call participant. The one of the caller or the callee might decide to merge the first call with the incoming call, and might send instructions indicating such. At block 430, the computer might receive, from the one of the caller or the callee, the instructions indicating merging of the incoming call with the first call. Method 400 might further comprise establishing, with the computer, a multi-party call connecting the caller, the callee, and each of the at least one additional call participant, in response to receiving the instructions indicating merging of the incoming call with the first call (block 410″).

In yet another alternative embodiment, method 400 might comprise receiving, with a computer and during a call between a caller and a callee, a request, from one of the caller or the callee, to add at least one additional call participant to the call (block 405″). At block 410″, method 400 might comprise establishing, with the computer, a multi-party call connecting the caller, the callee, and each of the at least one additional call participant, in response to receiving the request to add the at least one additional call participant to the call.

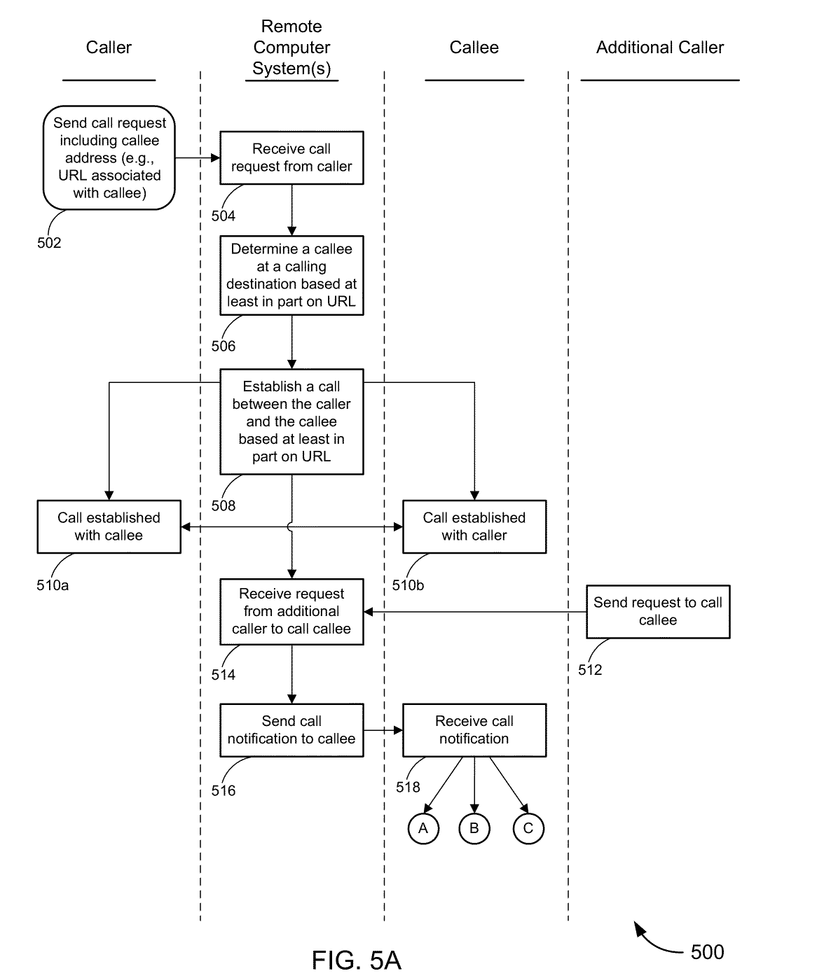

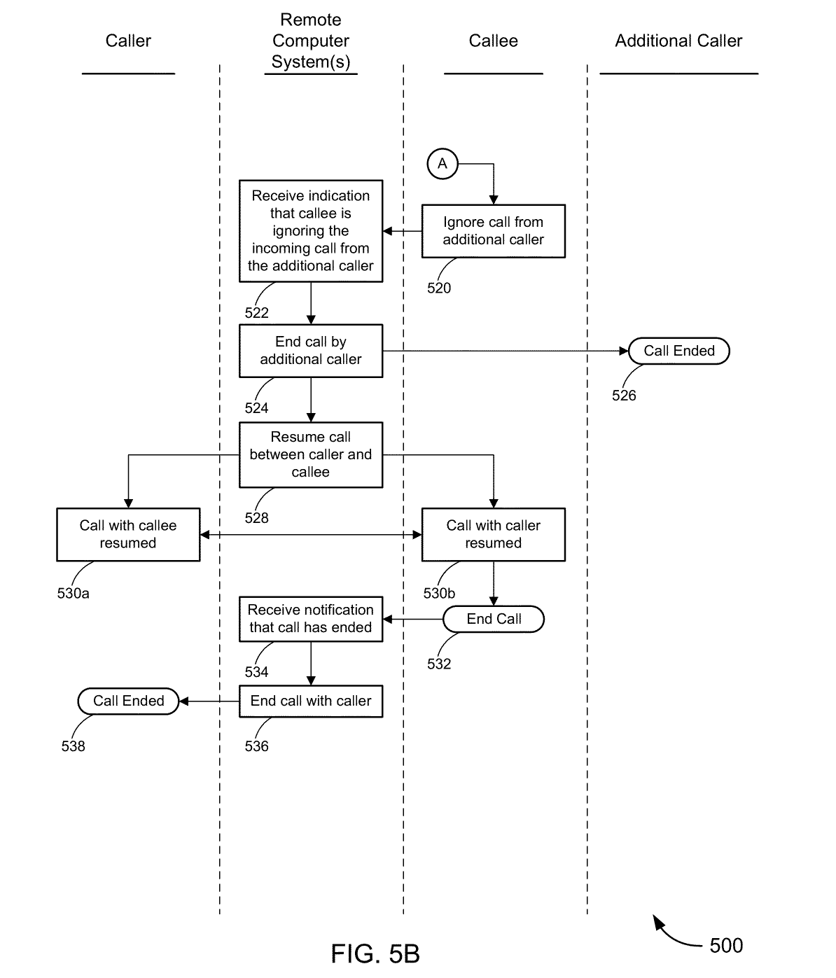

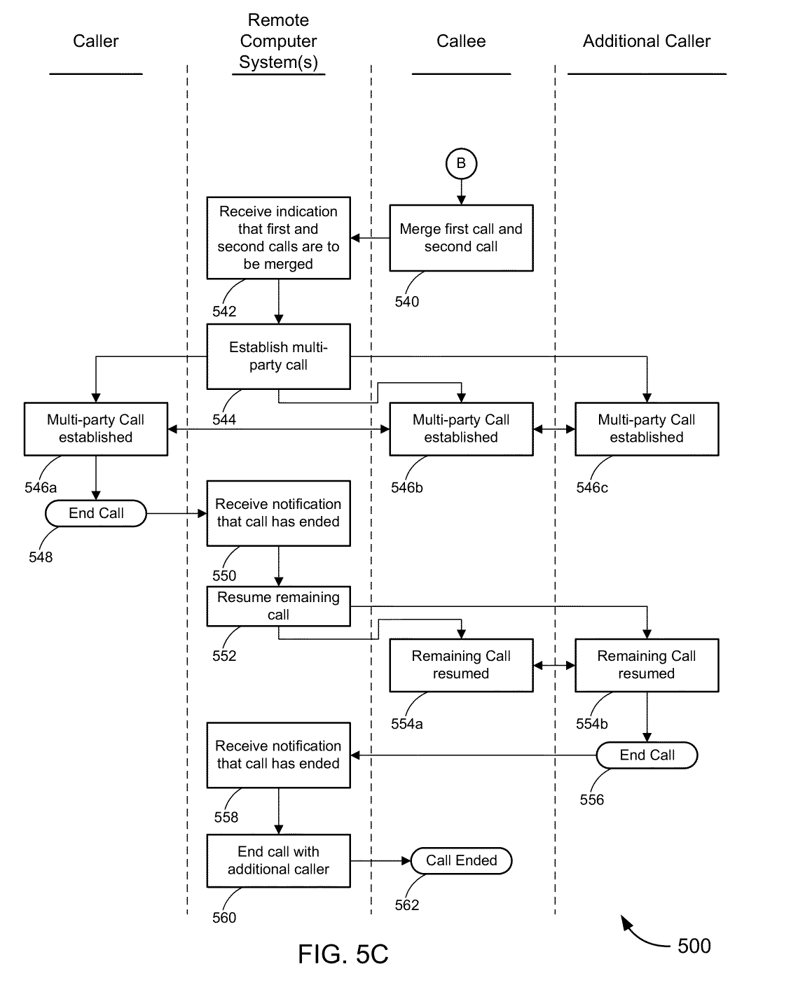

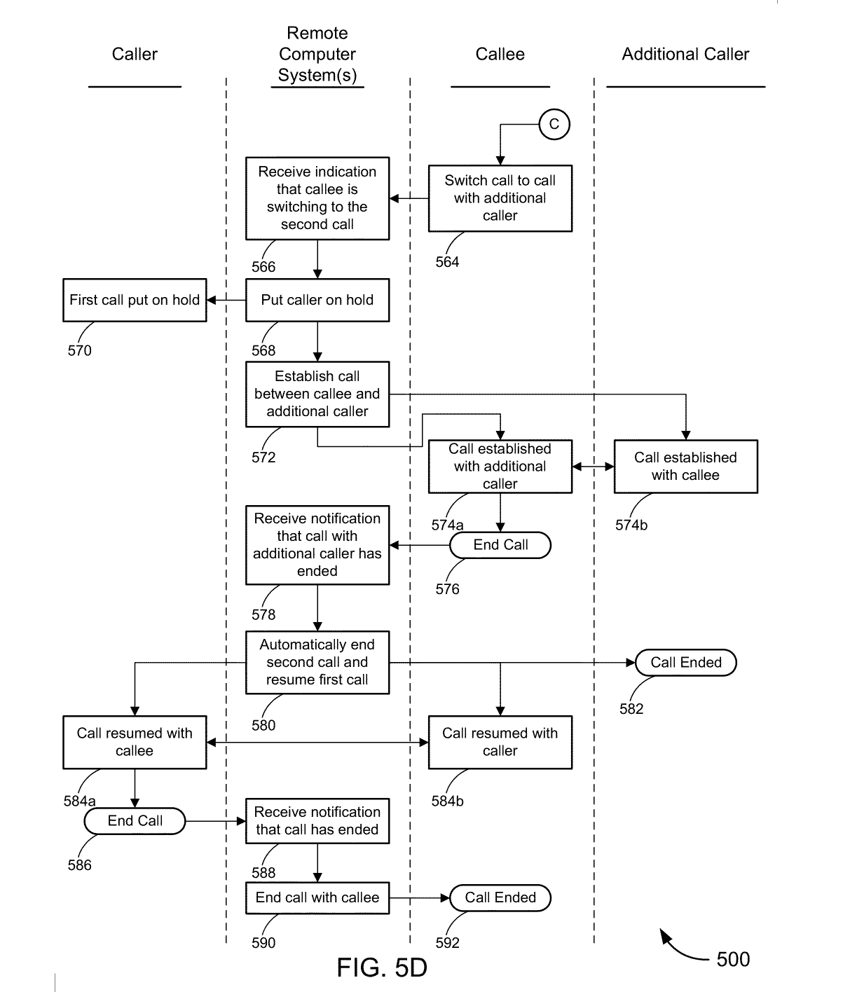

FIGS. 5A-5D (collectively, “FIG. 5”) represent a system flow diagram illustrating a method for enabling or implementing video or voice calling and conferencing addressing, in accordance with various embodiments. While the techniques and procedures are depicted and/or described in a certain order for purposes of illustration, it should be appreciated that certain procedures may be reordered and/or omitted within the scope of various embodiments. Moreover, while the method illustrated by FIG. 5 can be implemented by (and, in some cases, are described below with respect to) the systems 100, 700, and/or 800 of FIGS. 1, 7, and/or 8, respectively (or components thereof), such methods may also be implemented using any suitable hardware implementation. Similarly, while each of the system 100 (and/or components thereof) of FIG. 1, the system 700 (and/or components thereof) of FIG. 7, and/or the system 800 (and/or components thereof) of FIG. 8 can operate according to the method illustrated by FIG. 5 (e.g., by executing instructions embodied on a computer readable medium), the system 100 can also operate according to other modes of operation and/or perform other suitable procedures. In some embodiments, method 500 might be implemented complementary to method 200 of FIG. 2, method 300 of FIG. 3, and/or method 400 of FIG. 4, while in other embodiments, method 500 may be implemented independently, separately, or otherwise without implementing method 200, method 300, and/or method 400.

The method 500 in FIG. 5A continues onto FIG. 5B, linked by the circular marker denoted by “A,” continues onto FIG. 5C, linked by the circular marker denoted by “B,” continues onto FIG. 5D, linked by the circular marker denoted by “C.” FIG. 5A is directed to an embodiment in which a call is established between a caller and a callee, based at least in part on a URL associated with the callee (or with a device associated with the callee), and in which an additional caller calls the callee. FIG. 5B is directed to an embodiment in which the callee chooses to ignore the call from the additional caller and the processes that may follow. FIG. 5C is directed to an embodiment in which the callee chooses to merge the first call (with the caller) with the second or incoming call (with the additional caller) and the processes that may follow. FIG. 5D is directed to an embodiment in which the callee chooses to switch the call from the first call (with the caller) to the second or incoming call (with the additional caller) and the processes that follow.

Turning to FIG. 5A, method 500 might begin at block 502 with a caller (at a first device associated with the caller, including, but not limited to, one of a smartphone, a laptop computer, a desktop computer, a tablet computer, a video calling device, and/or the like) sending a call request, which might include a callee address (e.g., a URL associated with the callee or a URL associated with a device(s) associated with the callee). At block 504, a remote computer system(s) (e.g., control server 110 or web server 125 shown in FIG. 1) might receive the call request from the caller, and might determine, at block 506, a callee at a calling destination based at least in part on the URL (in a manner as described in detail above). Method 500 might further comprise the remote computer system(s) establishing a call between the caller and the callee based at least in part on the URL (block 508), the call being established (block 510a and 510b) between the caller and the callee (at a second device associated with the callee, including, but not limited to, one of a smartphone, a laptop computer, a desktop computer, a tablet computer, a video calling device, and/or the like).

At block 512, an additional caller (at a third device associated with the additional caller, including, but not limited to, one of a smartphone, a laptop computer, a desktop computer, a tablet computer, a video calling device, and/or the like) might send a request to call the callee, which request is received by the remote computer system(s) (block 514). The remote computer system(s) might, at block 516, send a call notification to the callee, which might be received, at block 518, by the callee. Based on choices by the callee as to how to handle the incoming call from the additional caller (including, but not limited to, ignoring the call (following marker “A” to FIG. 5B), merging the calls (following marker “B” to FIG. 5C), and/or switching the calls (following marker “C” to FIG. 5D), or the like), different sets of processes may be implemented.

Continuing onto FIG. 5B, the callee might, at block 520, ignore the incoming call from the additional caller, by pressing a button or clicking/following a link on a user interface running on the second device associated with the callee. Upon receiving an indication that the callee is ignoring the call from the additional caller (block 522), the remote computer system(s) might end the call by the additional caller (block 524), which might result in the call being ended (block 526) at the third device associated with the additional caller. At block 528, the remote computer system(s) might resume the first call between the caller and the callee, with the call being resumed (at blocks 530a and 530b) at the first device (associated with caller) and the second device (associated with the callee). In some embodiments, the first call between the caller and the callee continues without interruption in connection (except for the call notification to the callee about the incoming call from the additional callee and the instructions from the callee to ignore the call), and, in some cases, without the caller being aware of the exchange (unless told by the callee). At block 532, the callee might end the first call with the caller. Upon receiving a notification that the call has ended (block 534), the remote computer system(s) might end the call with the caller (block 536), which might result in the call being ended (block 538) at the first device associated with the caller.

In an alternative embodiment, and continuing onto FIG. 5C from (block 518 of) FIG. 5A, the callee might, at block 540, merge the first call with the second or incoming call from the additional caller, by pressing a button or clicking/following a link on a user interface running on the second device associated with the callee. Upon receiving an indication that the first and second calls are to be merged (block 542), the remote computer system(s) might establish a multi-party call (block 544), which connects the caller (block 546a), the callee (block 546b), and the additional caller (block 546c). In some embodiments, the transition from the two-party call to the multi-party call might be seamless. In some instances, the transition might include seamlessly transferring the call to a conferencing server for multiple callers; the conferencing server might be configured to perform aggregation and transcoding functions (as described above).

In the embodiment of FIG. 5C, the caller, during the multi-party call, might decide to end the call (block 548). Upon receiving a notification that the call with the caller has ended (block 550), the remote computer system(s) might resume the remaining call (block 552), with the call between the callee (block 554a) and the additional caller (block 554b) being resumed (in some cases, without interruption). In some cases, the transition from the multi-party call to the two-party call might be seamless. In some instances, the transition might include seamlessly transferring the call from the conferencing server for multiple callers. At block 556, the additional caller might end the call with the callee. Upon receiving a notification that the call has ended (block 558), the remote computer system(s) might end the call between the callee and the additional caller (block 560), which might result in the call being ended (block 562) at the second device associated with the callee.

In yet another alternative embodiment, and continuing onto FIG. 5D from (block 518 of) FIG. 5A, the callee might, at block 564, switch from the first call (with the caller) to the incoming call from the additional caller, by pressing a button or clicking/following a link on a user interface running on the second device associated with the callee. Upon receiving a notification that the callee is switching to the incoming call (block 566), the remote computer system(s) might put the caller on hold (block 568), which might result in the first call (at the first device) being put on hold (block 570). At block 572, the remote computer system(s) might establish a second call between the callee and the additional caller, which might result in the second call being established between the second device associated with the callee (block 574a) and the third device associated with the additional caller (block 574b).

At block 576, the callee might end the call with the additional caller. Upon receiving a notification that the call with the additional caller has ended (block 578), the remote computer system(s) might automatically end the second call with the additional caller and resume the first call with the caller (block 580), which might result in the second call being ended (block 582) at the third device associated with the additional caller, and the first call being resumed between the first device (block 584a) and the second device (block 584b). At block 586, the caller might end the first call with the callee. Upon receiving a notification that the call has ended (block 588), the remote computer system(s) might end the call with the callee (block 590), which might result in the call being ended (block 592) at the second device associated with the callee.

Although the various processes of method 500 are directed to an additional caller calling the callee, the various embodiments are not so limited, and similar processes may apply to the additional caller calling the caller. Likewise, although the embodiments of FIG. 5 depict an additional caller calling one of the parties in a two-party call, the various embodiments are not so limited, and similar processes may apply to the additional caller calling one or more parties in an existing multi-party call. Further, while the embodiments each show a particular one of two or more parties ending the call (e.g., at blocks 532, 548, 556, 576, and 586), for simplicity of illustration, various embodiments are not so limited, and similar processes may apply to any of the parties ending the call.

FIGS. 6A-6C (collectively, “FIG. 6”) are illustrations of user devices 600 used by users that present exemplary graphical user interfaces for enabling or implementing video or voice calling and conferencing addressing, in accordance with various embodiments. In particular, FIG. 6A is an illustration of a user device 600 used by users that presents an exemplary graphical user interface for presenting options for calling, options for device specific options related to calls, and options for account settings associated with a calling service, a calling app, a web browser for calling, and/or the like. FIG. 6B is an illustration of a user device used by users that presents an exemplary graphical user interface during a video call (or a voice call) with another person. FIG. 6C is an illustration of another user device used by users that presents another exemplary graphical user interface during a video call (or a voice call) with another person, with the system being capable of establishing multi-party calls.

In FIG. 6, although each user device 600 is shown as a smart phone or a monitor/television with a camera (whether internal or external), the various embodiments are not so limited, and user devices 600 might be any suitable user device comprising, without limitation, a high definition television (“HDTV”), an Internet Protocol television (“IPTV”), a cable TV, a desktop computer, a laptop computer, a tablet computer, a mobile phone, a smart phone, a portable gaming device, other suitable user devices, or any combination of these user devices.

User device 600 (which is associated with and/or used by a first user) might comprise device housing 605, a display screen 605a, and the like. In some embodiments, display screen 605a might comprise a touchscreen display, a non-touchscreen display, and/or the like. In the examples of FIG. 6, a panel 610 of a graphical user interface (“GUI”) might present options 610a (in the form of buttons, links, icons, and/or the like) including, without limitation, a menu option, a back option, a home option, a call option, a search option, and/or the like. Options 610a might be default options for the device 600, or might be options that are at least customizable by the first user. Other such options (or device functionalities, widgets, or apps) may be included by the first user in panel 610, as desired. Panel 615 might present a logo for a calling service, a calling app, a calling GUI, and/or the like. Other information, such as a status notification (including, “call with” someone, as shown in FIG. 6B) may also be displayed in panel 615, or in other portions of display screen 605a.

In the embodiment illustrated in FIG. 6A, a panel 620 might represent a first user's accounts page, which might be part of a calling service, a calling app, a calling GUI, and/or the like. The first user's accounts page might include options 625, which might comprise, but are not limited to, options pertaining to the first user's devices, options for accessing call settings, options for modifying account settings (including master account settings, user profile settings, user preferences, message preferences, and/or the like), and/or an option to logout of the first user's account page, or the like. In some instances, the message preferences might include, without limitation, options for accessing messages, which might include, but are not limited to, any one or combination of voicemail messages, videomail messages, e-mail messages, chat messages, text messages, and/or the like.

In some embodiments, the options for accessing messages might include, but are not limited to, options to view/hear/read one or more messages, options to mark one or more messages as being already viewed/heard/read, options to mark one or more messages as being not yet viewed/heard/read, options to save one or more messages, options to respond to one or more messages, options to forward one or more messages, options to delete one or more videomail messages, and/or the like. According to some aspects, the message preferences might further include, without limitation, preferences for notifying the first user of any new or not yet viewed/heard/read messages; preferences related to prompting callers to leave one or more of voicemail messages, videomail messages, e-mail messages, chat messages, text messages, and/or the like; preferences for recording message prompts; preferences related to post-processing of the messages; and/or the like.

In some embodiments, a message or notification might be sent from a service provider (in this non-limiting example, a videomail service provider) to the first user indicating that the first user associated with the user device 600 has received a new videomail message(s) from a caller. The notification might provide the first user with links to access the videomail message(s) and/or to access the first user's account information (including, without limitation, master account information, user profiles, user preferences related to videomail, videomail messages, and/or the like). The links might include one or more universal resource locators (“URLs”) addressing the videomail message(s), which in some cases have been post-processed (after recording) to be compatible with most (if not all) formats, play-back devices, resolutions, and/or the like. Similarly, for each of the other message types left by a caller, a notification might provide links or buttons to access the messages, and each message might be appropriately post-processed to be compatible with most (if not all) formats, play-back devices, resolutions, and/or the like.

With reference to FIG. 6B, during a call with a second user (such as a video (or voice) call in the non-limiting example of FIG. 6, which might be implemented using an image capture device 630 of the device 600), panel 615 might indicate a status including that the call has been established with the second user and is still on-going. Panel 635 might include windows or fields 640 and 645 that might each include video image (or still image in the case of a voice call) of the second user and the first user associated with the device 600, respectively. In some cases, video calls might occur without field 645 depicting a video of the first user of the device 600. In some instances, one of fields 640 or 645 might display a video image (e.g., a live video image), while the other of fields 640 or 645 might display a still (or default) image of a generic call participant, indicating that one of the call participants (i.e., the one with the still or default image) does not wish to transmit a video of himself or herself during the call; in such a case, the call that is established between the first and second users is a hybrid video/voice call.

In some embodiments, panel 650 might be displayed that presents options 655 (in the form of buttons, links, icons, and/or the like) including, without limitation, options for adding call participants, options for merging new callers (should they call the first user of the device 600), options for sharing the screen (or portions of the screen) of device 600, options for sharing files (including, but not limited, to photographs, images, videos, music, non-music audio files, documents, voicemail messages, videomail messages, e-mail messages, chat messages, text messages, apps, files containing communications protocols and data (for facilitating communications connections), and/or the like), options for giving control of camera 630 to one or more call participants, options for requesting control of a camera of a device associated with one or more call participants, options for recording the call, options for ending the call(s) (either ending selected calls or ending all calls), and/or the like.

Turning to FIG. 6C, an embodiment is shown that depicts a user device 600 (which in the non-limiting example of FIG. 6C is one of a HDTV, an IPTV, a cable TV, a monitor of a desktop computer, an external monitor for a laptop computer or for a tablet computer, and/or the like) that is associated with and/or used by a first user, and user interfaces for video communication. In the embodiment of FIG. 6C, user device 600 might comprise device housing 605, a display screen 605a, and the like. In some embodiments, display screen 605a might comprise a touchscreen display, a non-touchscreen display, and/or the like. In FIG. 6C, like in FIGS. 6A and 6B, panel 615 might present a logo for a calling service, a calling app, a calling GUI, and/or the like. Other information, such as a status notification, including a welcome message, may also be displayed in panel 615. In some embodiments, buttons, links, or icons for calling service account preferences, account/device settings, log-in or log-out options, and/or the like may also be displayed in panel 615, or in other portions of display screen 605a. Image capture device 630, in some cases, might be any suitable camera or other image capture device—either internal to, external to, or removably insertable (e.g., in a modular manner) in user device 600—that is capable of capturing images, video segments, audio segments, and/or any combination thereof. Where neither user device 600 nor image capture device 630 comprises an audio capture device, an external audio capture device (e.g., a microphone (not shown) or the like) might be used to capture audio segments or the like.

According to some embodiments, panel 635 (which might be a GUI of a browser, an app, a calling service, and/or the like) might include window(s) or field(s) 640 corresponding to communications with a second user (who may be the caller or the callee). Panel 635 might also include window(s) or field(s) 645 corresponding to communications options available to the first user (who may be the caller or the callee) who is associated with or using user device 600 in his or her communication with the second user. In some instances, window(s) or field(s) 640 might include, without limitation, a status message or status notification (such as, “Incoming call from ______”; “Incoming message from ______”; “New message(s) from ______”; or, as in this example, “Call with Nadeem!”; and/or the like), a sub-window, sub-field, or sub-panel 640a, and/or the like. In some cases, sub-window, sub-field, or sub-panel 640a might include display of a live video feed or a still image of the second user, or might include display of a default icon or image of a generic call participant.

In some embodiments, window(s) or field(s) 640 might include one or more buttons, links, and/or icons 655a, which might include, without limitation, options to put the call on hold, options to record the call, options to share at least a portion of screen 605a, options to share files, options to give the second user control over camera 630, options to request control of a camera(s) of a device associated with the second user (in some cases, the camera(s) used for capturing the image(s) or video displayed in sub-panel 640a), other options, options to end the call with (only) the second user, and/or the like. In some cases, where the first user has already requested control of a camera of a device associated with or used by the second user, and the second user has allowed camera control to the first user, the button, link, text, and/or icon for requesting camera control might be made unavailable, invisible, grayed out, and/or the like. Also in such a case, sub-window, sub-field, or sub-panel 660 might be displayed that provides the first user with camera control over the camera of the device associated with and/or used by the second user.

In some embodiments, sub-window, sub-field, or sub-panel 660 might provide camera controls, including, but not limited to, pan (“P”) controls, tilt (“T”) controls, zoom (“Z”) controls, and/or the like. In some cases, the camera controls might further include, without limitation, autofocus (“AF”) controls, centering (“C”)/home/position reset controls, iris controls, manual focus controls, still image capture controls, multi-shot still image capture controls, and/or the like. In some instances, the pan and tilt (“PT”) controls might be embodied as separate buttons (not shown), in which the top arrow might control a forward tilt, the down arrow might control a backward tilt, the left arrow might control a leftward pan, the right arrow might control a rightward pan, and arrows between these arrows might control a combination of pan and tilt. In the case that the PT controls are embodied as a ring control or dial control (e.g., as shown in FIG. 6C), clicking, depressing, dragging, or otherwise manipulating a cursor or other indicator over portions of the ring or dial causes varying combinations of pan and tilt, that in some cases provides for smoother tracking of objects or persons within the field of view of the camera.

According to some embodiments, other modes of communication (including, without limitation, text communication, chat communication, e-mail communication, and/or the like) may be made available within window(s) or field(s) 640. The example of FIG. 6C shows, for example, sub-window, sub-field, or sub-panel 665 that provides for chat communication functionality with the second user.

Merely by way of example, in some aspects, window(s) or field(s) 645 might provide the first user with various controls or options during communication with other users. Such various controls or options might include, without limitation, options 670 for controlling volume (including, increasing volume, decreasing volume, manipulating volume slider control, muting/unmuting, and/or the like), sub-panel 645a (optional) for displaying an image or video of the first user (using image capture device 630), options 675 for controlling image capture device 630 (in a similar manner as the camera controls described above with respect to sub-window, sub-field, or sub-panel 660), options 680 for initiating a call with the second user or an additional call participant, call options 655b, sub-window, sub-field, or sub-panel 665 that provides for communication functionality (including, without limitation, text communication, chat communication, e-mail communication, and/or the like) with a group of call participants, more call options 655c, and/or the like. For options 675, the options for controlling image capture device 630 might include controls for control internal mechanisms for controlling pan, tilt, zoom, iris, focus, centering, and/or the like of a camera within device 630, and/or controls for controlling external mechanisms for at least adjusting the pan and tilt of the exterior/entire body (or a mount) of device 630.

According to some embodiments, other modes of communication (including, without limitation, text communication, chat communication, e-mail communication, and/or the like) may be made available to provide group communications other than video or voice communications. The example of FIG. 6C shows, for example, sub-window, sub-field, or sub-panel 685 that provides for group chat communication functionality with two or more other users. Because the call with the third user has not yet been established, the only user in communication with the first user is the second user, thus only the sub-window, sub-field, or sub-panel 665 (associated with another mode of communication with the second user) is shown to be active, while the group chat field 685 is shown as being grayed out; once the call is connected with at least one more user (e.g., third user or incoming caller), the sub-window, sub-field, or sub-panel 685 will be displayed normally (similar to sub-window, sub-field, or sub-panel 665) (i.e., will be indicated as being active). In some embodiments, where the call involves four or more users, the group chat functionality may be provided to allow the first user to communicate with two or more (but not necessarily all) other call participants through a group chat functionality; in such a case, the group chat function might display a selection list (not shown, but perhaps with radio boxes, check boxes, and/or the like) for the first user to select which of the other call participants (i.e., two, less than all, or all other call participants) to whom the first user would like to send a message.

In some cases, options 680 might include links to calling addresses of potential call participants (such as from the first user's contacts list, a public directory, a company directory, and/or the like), that when clicked, followed, or entered might initiate a call with the selected individual(s). Alternatively, selection check boxes or the like adjacent to each potential call participant might be provided, thus allowing the first user to select which potential call participants to call (or add to an existing call), in which case, clicking, depressing, or following a button, link, or icon to “add call participants” (as shown among options 655b in FIG. 6C, for example) might initiate the call or merge the calls. In some instances, a URL associated with a callee or with a device of a callee might be entered within a URL input field of a browser (e.g., web browser, etc.), or the like. In terms of calling or conferencing addressing, the calling addresses might include, without limitation, URLs, JIDs, and/or telephone numbers associated with each of the potential call participants and/or associated with one or more devices associated with each of the potential call participants. Examples of URLs and JIDs are provided above with respect to FIG. 2.

Options 655b and options 655c might include, but are not limited to, options to add or call particular call participants, options to access a contacts list, other options, message options, options to simultaneously end all active calls, and/or the like. In some cases, other options might include options to list active call participants, to end specific calls with selected one(s) of the active call participants (and not others), to send sub-group messages (e.g., e-mail, chat, and/or text) to selected one(s) of the active call participants (and not others), to share at least a portion of display screen 605a with selected one(s) of the active call participants (and not others), to share one or more files with selected one(s) of the active call participants (and not others), to give camera control to selected one(s) of the active call participants (and not others), and/or the like.

In some embodiments, during a two-party call with the second user (or a multi-party call involving the second user), the first user might receive an incoming call request from a third user, which might result in a notification field or a window(s) or field(s) 690 being displayed. In some cases, window(s) or field(s) 690 might include a status message indicating “Incoming Call from ______!” (e.g., “Incoming Call from Chad!” in the example of FIG. 6C), which might include an alert icon (such as shown in top-right region of window(s) or field(s) 690). According to some embodiments, window(s) or field(s) 690 might include sub-window, sub-field, or sub-panel 690a, sub-window, sub-field, or sub-panel 695, and/or both. Sub-window, sub-field, or sub-panel 690a might, when the call with the third user is accepted and established, display a live video feed or a still image of the second user, or might display a default icon or image of a generic incoming caller. Because the call with the third user has not yet been established, the sub-window, sub-field, or sub-panel 690a is shown as being grayed out; once the call is connected with the third user, the sub-window, sub-field, or sub-panel 690a will be displayed normally (similar to sub-window, sub-field, or sub-panel 640a) (i.e., will be indicated as being active).

In some embodiments, window(s) or field(s) 690 might include one or more buttons, links, and/or icons 655d, which might include, without limitation, options to put the call on hold, options to send a message to the incoming caller, options to switch from the current call with the second user to the incoming call from the third user, options to let the third user join the current call with the second user (i.e., to merge the calls), other options, options to end the call with (only) the third user (before it is connected), and/or the like.

According to some embodiments, other modes of communication (including, without limitation, text communication, chat communication, e-mail communication, and/or the like) may be made available within window(s) or field(s) 690. The example of FIG. 6C shows, for example, sub-window, sub-field, or sub-panel 695 that provides for chat communication functionality with the third user. Because the call with the third user has not yet been established, the chat field 695 is shown as being grayed out (similar to the image of the third user being grayed out in sub-window, sub-field, or sub-panel 690a); once the call is connected with the third user, the sub-window, sub-field, or sub-panel 695 will be displayed normally (similar to sub-window, sub-field, or sub-panel 665) (i.e., will be indicated as being active).

Although FIG. 6 is directed to embodiments featuring video calling, the various embodiments are not so limited, and any type of communication (including, but not limited to, voice communication, e-mail communication, text communication, chat communication, video communication, and/or any combination of these communications) may be implemented using the system(s) and method(s) described herein, and using the user interfaces (or similar user interfaces) shown and described with respect to FIG. 6.

FIG. 7 provides a schematic illustration of one embodiment of a computer system 700 that can perform the methods provided by various other embodiments, as described herein, and/or can function as a video calling device, a PDD, a user device, a control server, a web server, and/or the like. It should be noted that FIG. 7 is meant only to provide a generalized illustration of various components, of which one or more (or none) of each may be utilized as appropriate. FIG. 7, therefore, broadly illustrates how individual system elements may be implemented in a relatively separated or relatively more integrated manner.

The computer system 700 is shown comprising hardware elements that can be electrically coupled via a bus 705 (or may otherwise be in communication, as appropriate). The hardware elements may include one or more processors 710, including, without limitation, one or more general-purpose processors and/or one or more special-purpose processors (such as digital signal processing chips, graphics acceleration processors, and/or the like); one or more input devices 715, which can include, without limitation, a mouse, a keyboard, and/or the like; and one or more output devices 720, which can include, without limitation, a display device, a printer, and/or the like.

The computer system 700 may further include (and/or be in communication with) one or more storage devices 725, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer system 700 might also include a communications subsystem 730, which can include, without limitation, a modem, a network card (wireless or wired), an infra-red communication device, a wireless communication device and/or chipset (such as a Bluetooth™ device, an 802.11 device, a WiFi device, a WiMax device, a WWAN device, cellular communication facilities, etc.), and/or the like. The communications subsystem 730 may permit data to be exchanged with a network (such as the network described below, to name one example), with other computer systems, and/or with any other devices described herein. In many embodiments, the computer system 700 will further comprise a working memory 735, which can include a RAM or ROM device, as described above.

The computer system 700 also may comprise software elements, shown as being currently located within the working memory 735, including an operating system 740, device drivers, executable libraries, and/or other code, such as one or more application programs 745, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 725 described above. In some cases, the storage medium might be incorporated within a computer system, such as the system 700. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer system 700 and/or might take the form of source and/or installable code, which, upon compilation and/or installation on the computer system 700 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 700) to perform methods in accordance with various embodiments of the invention. According to a set of embodiments, some or all of the procedures of such methods are performed by the computer system 700 in response to processor 710 executing one or more sequences of one or more instructions (which might be incorporated into the operating system 740 and/or other code, such as an application program 745) contained in the working memory 735. Such instructions may be read into the working memory 735 from another computer readable medium, such as one or more of the storage device(s) 725. Merely by way of example, execution of the sequences of instructions contained in the working memory 735 might cause the processor(s) 710 to perform one or more procedures of the methods described herein.

According to some embodiments, system 700 might further comprise one or more sensors 750, which might include, without limitation, one or more cameras, one or more IR sensors, and/or one or more 3D sensors, or the like. In some cases, the one or more sensors 750 might be incorporated in (or might otherwise be one of) the input device(s) 715. The output device(s) 720 might, in some embodiments, further include one or more monitors, one or more TVs, and/or one or more display screens, or the like.

The terms “machine readable medium” and “computer readable medium,” as used herein, refer to any medium that participates in providing data that causes a machine to operate in a specific fashion. In an embodiment implemented using the computer system 700, various computer readable media might be involved in providing instructions/code to processor(s) 710 for execution and/or might be used to store and/or carry such instructions/code (e.g., as signals). In many implementations, a computer readable medium is a non-transitory, physical, and/or tangible storage medium. Such a medium may take many forms, including, but not limited to, non-volatile media, volatile media, and transmission media. Non-volatile media includes, for example, optical and/or magnetic disks, such as the storage device(s) 725. Volatile media includes, without limitation, dynamic memory, such as the working memory 735. Transmission media includes, without limitation, coaxial cables, copper wire and fiber optics, including the wires that comprise the bus 705, as well as the various components of the communication subsystem 730 (and/or the media by which the communications subsystem 730 provides communication with other devices). Hence, transmission media can also take the form of waves (including, without limitation, radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 710 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 700. These signals, which might be in the form of electromagnetic signals, acoustic signals, optical signals, and/or the like, are all examples of carrier waves on which instructions can be encoded, in accordance with various embodiments of the invention.

The communications subsystem 730 (and/or components thereof) generally will receive the signals, and the bus 705 then might carry the signals (and/or the data, instructions, etc. carried by the signals) to the working memory 735, from which the processor(s) 705 retrieves and executes the instructions. The instructions received by the working memory 735 may optionally be stored on a storage device 725 either before or after execution by the processor(s) 710.

As noted above, a set of embodiments comprises systems enabling or implementing video calling and conferencing addressing. FIG. 8 illustrates a schematic diagram of a system 800 that can be used in accordance with one set of embodiments. The system 800 can include one or more user computers 805. In particular, a user computer 805 can be a video calling device, a PDD, and/or a user device, as described above. More generally, a user computer 805 can be a general purpose personal computer (including, merely by way of example, desktop computers, workstations, tablet computers, laptop computers, handheld computers, mobile phones, smart phones, and the like), running any appropriate operating system, several of which are available from vendors such as Apple, Microsoft Corp., as well a variety of commercially-available UNIX™ or UNIX-like operating systems. A user computer 805 can also have any of a variety of applications, including one or more applications configured to perform methods provided by various embodiments (as described above, for example), as well as one or more office applications, database client and/or server applications, and/or web browser applications. Alternatively, a user computer 805 can be any other electronic device, such as a thin-client computer, Internet-enabled mobile telephone, and/or personal digital assistant, capable of communicating via a network (e.g., the network 810 described below) and/or of displaying and navigating web pages or other types of electronic documents. Although the exemplary system 800 is shown with two user computers 805, any number of user computers can be supported.

Certain embodiments operate in a networked environment, which can include a network 810. The network 810 can be any type of network familiar to those skilled in the art that can support data communications using any of a variety of commercially-available (and/or free or proprietary) protocols, including, without limitation, TCP/IP, SNA™, IPX™, AppleTalk™, and the like. Merely by way of example, the network 810 can include a local area network (“LAN”), including, without limitation, a fiber network, an Ethernet network, a Token-Ring™ network and/or the like; a wide-area network; a wireless wide area network (“WWAN”); a virtual network, such as a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments can also include one or more server computers 815. Each of the server computers 815 may be configured with an operating system, including, without limitation, any of those discussed above with respect to the user computers 805, as well as any commercially (or freely) available server operating systems. Each of the servers 815 may also be running one or more applications, which can be configured to provide services to one or more clients 805 and/or other servers 815.

Merely by way of example, one of the servers 815 might be a control server, with the functionality described above. In another embodiment, one of the servers might be a web server, which can be used, merely by way of example, to provide communication between a user computer 805 and a control server, for example, to process requests for web pages or other electronic documents from user computers 805 and/or to provide user input to the control server. The web server can also run a variety of server applications, including HTTP servers, FTP servers, CGI servers, database servers, Java servers, and/or the like. In some embodiments of the invention, the web server may be configured to serve web pages that can be operated within a web browser on one or more of the user computers 805 to perform operations in accordance with methods provided by various embodiments.

The server computers 815, in some embodiments, might include one or more application servers, which can be configured with one or more applications accessible by a client running on one or more of the client computers 805 and/or other servers 815. Merely by way of example, the server(s) 815 can be one or more general purpose computers capable of executing programs or scripts in response to the user computers 805 and/or other servers 815, including, without limitation, web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming and/or scripting languages. The application server(s) can also include database servers, including, without limitation, those commercially available from Oracle™, Microsoft™, Sybase™, IBMT™, and the like, which can process requests from clients (including, depending on the configuration, dedicated database clients, API clients, web browsers, etc.) running on a user computer 805 and/or another server 815. In some embodiments, an application server can create web pages dynamically for displaying the information in accordance with various embodiments, such as providing a user interface for a control server, as described above. Data provided by an application server may be formatted as one or more web pages (comprising HTML, JavaScript, etc., for example) and/or may be forwarded to a user computer 805 via a web server (as described above, for example). Similarly, a web server might receive web page requests and/or input data from a user computer 805 and/or forward the web page requests and/or input data to an application server. In some cases, a web server may be integrated with an application server.

In accordance with further embodiments, one or more servers 815 can function as a file server and/or can include one or more of the files (e.g., application code, data files, etc.) necessary to implement various disclosed methods, incorporated by an application running on a user computer 805 and/or another server 815. Alternatively, as those skilled in the art will appreciate, a file server can include all necessary files, allowing such an application to be invoked remotely by a user computer 805 and/or server 815.

It should be noted that the functions described with respect to various servers herein (e.g., application server, database server, web server, file server, etc.) can be performed by a single server and/or a plurality of specialized servers, depending on implementation-specific needs and parameters. Further, as noted above, the functionality of one or more servers 815 might be implemented by one or more containers or virtual machines operating in a cloud environment and/or a distributed, cloud-like environment based on shared resources of a plurality of user devices, a plurality of user video calling devices, and/or a plurality of PDDs.

In certain embodiments, the system can include one or more data stores 820. The nature and location of the data stores 820 is discretionary: merely by way of example, one data store 820 might comprise a database 820a that stores information about master accounts, user profiles, user preferences, assigned video calling devices, etc. Alternatively and/or additionally, a data store 820b might be a cloud storage environment for storing master accounts, user profiles, user preferences, uploaded videomail messages, and/or the like. In some embodiments, at least one of the data stores 820 might store user addresses including, but not limited to, URL associated with one or more users, URL associated with at least one device associated with one or more users, SIP address association with one or more users, XMPP address (or Jabber ID or JID) associated with one or more users, telephone number associated with one or more users, and/or the like. According to some embodiments, at least one of the data stores 820 might store recorded voice calls or recorded video calls.

As the skilled reader can appreciate, the database 820a and the cloud storage environment 820b might be collocated and/or separate from one another. Some or all of the data stores 820 might reside on a storage medium local to (and/or resident in) a server 815a. Conversely, any of the data stores 820 (and especially the cloud storage environment 820b) might be remote from any or all of the computers 805, 815, so long as it can be in communication (e.g., via the network 810) with one or more of these. In a particular set of embodiments, a database 820a can reside in a storage-area network (“SAN”) familiar to those skilled in the art, and/or the cloud storage environment 820b might comprise one or more SANs. (Likewise, any necessary files for performing the functions attributed to the computers 805, 815 can be stored locally on the respective computer and/or remotely, as appropriate.) In one set of embodiments, the database 820a can be a relational database, such as an Oracle database, that is adapted to store, update, and retrieve data in response to SQL-formatted commands. The database might be controlled and/or maintained by a database server, as described above, for example.

As noted above, the system can also include a first video calling device 825 and a second video calling device 830. The first video calling device 825 in the context of the examples described herein might correspond to the device associated with the user or caller, while the second video calling device 830 might correspond to the device associated with the callee. The system might further include a third video calling device 835 from which one or more additional call participants can call one of the caller or callee, can be added as an additional party(ies) to the call (turning the call into a multi-party call), or can be called by one of the caller or callee without being included in a multi-party call with both the caller and the callee. Although only three video calling devices are illustrated in FIG. 8, it should be appreciated that any number of video calling devices 825-835 (associated with any number of users) may be implemented in accordance with various embodiments.

Using the techniques described herein, the first video calling device 825 or the second video calling device 830 can determine whether or not to accept/ignore a call by the additional call participant using the third video calling device 835, to switch from a first call between the caller and the callee to a second call with the call participant, to merge the first call and the second call, and/or the like. Each of the first video calling device 825, the second video calling device 830, and/or the third video calling device 835 may be (or may have similar functionality as) a user device 105, a video calling device 105 or a PDD 105, as described in detail above; in some cases, each of the first video calling device 825, the second video calling device 830, and the third video calling device 835 might be (or may have similar functionality as) a VCD as described in the '182 patent.

Although the various embodiments are directed specifically to video calls and video calling devices, the embodiments are not so limited and any type of communication device may be used in accordance with techniques described herein, including, but not limited to, voice communication devices, e-mail communication devices, text communication devices, multimedia communication devices, and/or the like.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware, and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added, and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
receiving, at a computer and from a caller, a call request including a callee address in a first protocol, wherein the first protocol is hypertext transfer protocol (“HTTP”), and the callee address includes a uniform resource locator (“URL”) associated with the callee;
determining, with the computer, a callee at a calling destination based at least in part on the URL associated with the callee; and
establishing, with the computer, a call between the caller and the callee based at least in part on the URL associated with the callee.

2. The method of claim 1, wherein the computer is a server located over a network.

3. The method of claim 1, wherein the URL associated with the callee is a URL associated with at least one device associated with the callee.

4. The method of claim 1, wherein establishing the call between the caller and the callee based at least in part on the URL associated with the callee comprises:
mapping, with the computer, a callee address in a second protocol different from the first protocol;
logging into a calling server that utilizes the second protocol, via the computer; and
initiating, with the computer, a call to the callee address in the second protocol based on the mapping.

5. The method of claim 4, wherein the second protocol is session initiation protocol (“SIP”), and the callee address includes a SIP address associated with the callee.

6. The method of claim 4, wherein the second protocol is extensible messaging and presence protocol (“XMPP”), and the callee address includes an XMPP address associated with the callee.

7. The method of claim 4, wherein the second protocol is public switched telephone network (“PSTN”) protocol, and the callee address includes a telephone number associated with the callee.

8. The method of claim 1, wherein the call is a video call.

9. The method of claim 8, further comprising:
recording, with the computer, the video call; and
storing, with the computer, the recorded video call in a database.

10. The method of claim 1, wherein the callee is one of a software application, a dedicated hardware device, a web browser, or a conferencing server for multiple callers, wherein the conferencing server performs aggregation and transcoding functions.

11. The method of claim 1, wherein the call request is initiated by the caller entering the URL associated with the callee in a web browser.

12. The method of claim 1, further comprising:
receiving, with the computer, a request to share with the callee a display screen of a first device associated with the caller; and
displaying the display screen of a first device on a screen of a second device associated with the callee, in response to receiving the request to share the display screen of a first device associated with the caller.

13. The method of claim 1, further comprising:
receiving, with the computer, a request to share files with the callee; and
transferring, with the computer, one or more files designated for sharing from a first device associated with the caller to a second device associated with the callee, in response to receiving the request to share files.

14. The method of claim 1, further comprising:
receiving, with the computer, a request to provide the callee with control of a camera associated with the caller; and
providing, with the computer, remote control of the camera associated with the caller to the callee.

15. The method of claim 14, wherein remote control of the camera associated with the caller includes control of at least one of pan, tilt, or zoom of the camera.

16. The method of claim 14, wherein the call is a video call, and wherein the camera is a camera used by the caller during the video call.

17. The method of claim 1, wherein the computer is a HTTP server, wherein establishing the call between the caller and the callee based at least in part on the URL associated with the callee comprises:
receiving, with the HTTP server and from a browser of a first device associated with the caller, a first notification indicating an incoming call;
sending, with the HTTP server, a second notification to the callee indicating the incoming call; and
relaying, with the HTTP server, control information and data to establish the call between the caller and the callee.

18. The method of claim 17, wherein the HTTP server has WebSocket (“WS”) connection functionality.

19. The method of claim 17, further comprising:
routing, with the HTTP server, traffic over a content delivery network (“CDN”).

20. The method of claim 1, wherein the computer is a HTTP server, wherein establishing the call between the caller and the callee based at least in part on the URL associated with the callee comprises:
receiving, with the HTTP server and from a browser of a first device associated with the caller, a first notification indicating an incoming call;
sending, with the HTTP server, a second notification to the callee indicating the incoming call;
providing, with the HTTP server and to each of the first device associated with the caller and a second device associated with the callee, at least one of the caller address, the callee address, or control information and data; and
establishing the call between the caller and the callee, by streaming the control information and data from each of the first device and the second device to the other of the first device and the second device.

21. The method of claim 1, further comprising:
maintaining, with the computer, a connection between the computer and a second device associated with the callee; and
waking, with the computer, a browser running on the second device in response to receiving a notification of an incoming call.

22. The method of claim 21, wherein maintaining, with the computer, the connection between the computer and the second device associated with the callee comprises utilizing a WebSocket (“WS”) connection.

23. The method of claim 21, wherein maintaining, with the computer, the connection between the computer and the second device associated with the callee comprises:
associating the second device with the computer;
authenticating an identity of the callee through the second device; and
maintaining the connection based at least in part on the association and the authentication.

24. The method of claim 21, wherein waking, with the computer, the browser running on the second device comprises waking, with the computer, the browser using a side communications channel between the computer and the second device.

25. The method of claim 21, wherein waking, with the computer, the browser running on the second device comprises simultaneously waking, with the computer, all browsers running on all devices associated the callee.

26. The method of claim 1, further comprising:
receiving, with the computer and during the call between the caller and the callee, a request to establish a multi-party call with at least one additional call participant, the at least one additional call participant being separate from both the caller and the callee; and
establishing, with the computer, a multi-party call connecting the caller, the callee, and each of the at least one additional call participant.

27. The method of claim 26, wherein the request to establish the multi-party call includes a request to join the call that is received from the at least one additional call participant, and wherein establishing the multi-party call comprises:
sending, with the computer, a notification to each of the caller and the callee indicating the request to join the call that is received from the at least one additional call participant;
receiving, from one of the caller or the callee, instructions indicating acceptance of the at least one additional call participant in joining the call; and
establishing, with the computer, a multi-party call connecting the caller, the callee, and each of the at least one additional call participant, in response to receiving the instructions indicating acceptance of the at least one additional call participant in joining the call.

28. The method of claim 26, wherein the request to establish the multi-party call includes a request, from one of the caller or the callee, to add the at least one additional call participant to the call, and wherein establishing the multi-party call comprises establishing, with the computer, a multi-party call connecting the caller, the callee, and each of the at least one additional call participant, in response to receiving the request to add the at least one additional call participant to the call.

29. The method of claim 26, wherein establishing, with the computer, a multi-party call connecting the caller, the callee, and each of the at least one additional call participant comprises seamlessly transferring the multi-party call to a conferencing server.

30. The method of claim 1, further comprising:
receiving, with the computer and during a first call between the caller and the callee, a request from an additional caller to call one of the caller or the callee, the additional caller being separate from both the caller and the callee;
in response to receiving an ignore call user input response from the one of the caller or the callee, preventing establishment of a call connection between the additional caller and the one of the caller or the callee, without interrupting the first call; and
in response to receiving a switch call user input response from the one of the caller or the callee, putting the first call on hold and establishing a second call between the additional caller and the one of the one of the caller or the callee.

31. The method of claim 30, further comprising:
in response to receiving an end call user input response from the one of the caller or the callee to end the second call, automatically resuming the first call.

32. An apparatus, comprising:
a non-transitory computer readable medium that is communicatively coupled to at least one processor, the computer readable medium having stored thereon software comprising a set of instructions that, when executed by the at least one processor, causes the apparatus to perform one or more functions, the set of instructions comprising:
instructions for receiving, from a caller, a call request including a callee address in a first protocol, wherein the first protocol is hypertext transfer protocol (“HTTP”), and the callee address includes a uniform resource locator (“URL”) associated with the callee;
instructions for determining a callee at a calling destination based at least in part on the URL associated with the callee; and
instructions for establishing a call between the caller and the callee based at least in part on the URL associated with the callee.

33. The apparatus of claim 32, wherein the apparatus is a user device associated with the caller, and wherein the instructions for establishing the call comprise instructions for sending a request to a server over a network to establish the call.

34. The apparatus of claim 32, wherein the apparatus is a server over a network.
